(19) United States
(12) Patent Application Publication
(10) Pub. No.: US 2012/0025651 A1
(43) Pub. Date: Feb. 2, 2012

(54) SINTERED MAGNET AND ROTATING ELECTRIC MACHINE USING SAME

(76) Inventors: Matahiro Komuro, Hitachi (JP); Yuichi Satsu, Hitachi (JP); Hiroyuki Suzuki, Hitachi (JP); Takao Imagawa, Mito (JP)

(21) Appl. No.: 13/257,331

(22) PCT Filed: Feb. 18, 2010
(86) PCT No.: PCT/JP2010/001030

§ 371 Date: Oct. 21, 2011

(30) Foreign Application Priority Data
Mar. 27, 2009 (JP) 2009-078002

(51) Int. Cl. H01F 1/04; H02K 21/02

(52) U.S. Cl. 310/152; 252/62.55

(57) ABSTRACT

A sintered magnet according to the present invention is a sintered magnet configured from a magnetic powder grain having Nd₂Fe₁₄B as a main component, in which: fluorine, a heavy rare earth element, oxygen, and carbon are segregated in part of grain-boundary regions of said sintered magnetic powder grain; concentration of the carbon is higher than concentration of the fluorine at a grain-boundary triple junction of the grain-boundary region; and concentration of the heavy rare earth element decreases from said grain-boundary triple junction toward an inside of said magnetic powder grain.

### TECHNICAL FIELD OF THE INVENTION

The present invention relates to a rare earth magnet and a rotating electric machine using the magnet.

### DESCRIPTION OF BACKGROUND ART

Patent literature 1 (Japanese Patent Laid-open No. 2003-282312) discloses a rare earth sintered magnet containing a fluoride or an oxyfluoride produced by dry blending or wet blending an alloy powder for sintered magnets and a fluoride powder, orienting the mixture in a magnetic field, compressing the mixture, and sintering the compressed body. However, since the method is based on the blending of powders, the contact between the alloy powder for sintered magnets and the fluoride powder is not a face contact but tends to be a point contact. Accordingly, to efficiently form a reaction phase (the phase including fluorine), a large amount of fluoride powders and high temperature and prolonged time heat treatment are required. Furthermore, it is difficult to uniformly form a reaction phase along the surface of the magnet powder.

Furthermore, patent literature 2 (US 2005/0081959 A1) discloses an example of a bond magnet produced by blending a rare earth fluoride micro powder (1 to 20 μm) and an Nd—Fe—B (neodymium-iron-boron) powder. However, there is no report indicating that a sheet-like reaction phase diffuses and grows in the grains of the magnet powder.

Furthermore, non-patent literature 1 (reports by Nakamura et al.) discloses an Nd—Fe—B sintered magnet produced by coating the surface of a micro sintered magnet with a DyF₃ or TbF₃ micro powder (1 to 5 μm), and reports that Dy (dysprosium) or F (fluorine) is absorbed into the sintered magnet body thereby forming NdOF or an Nd oxide. However, the fluoride coating method is not solution treatment, and nothing is written about the concentration distribution of carbon, a heavy rare earth, or a light rare earth in an oxyfluoride formed at the grain-boundary triple junction.
Patent literature 1: Japanese Patent Laid-open No. 2003-282312;
Patent literature 2: US2005/0081959A1; and
Nonpatent literature 1: H. Nakamura, K. Hirota, M. Shimao, T. Minowa, and M. Honshima: “Hard Magnetic Materials and Applications—Magnetic Properties of Extremely Small Nd—Fe—B Sintered Magnets”, IEEE Transactions on Magnetics, vol. 41 no. 10 (2005) 3844-3846.

### DISCLOSURE OF INVENTION

### Problems to be Solved by the Invention

As stated above, since the above conventional technology is based on the solid phase reaction by powder blending to form a reaction phase containing fluorine around the Nd—Fe—B magnetic powder, it is necessary to increase heat treatment temperature to increase diffusion rate. To do so, it was difficult to increase magnetic characteristics and achieve low concentration of a rare earth element by forming a reaction phase containing a fluorine around the magnetic powder, especially for the magnetic powder whose magnetic characteristics deteriorates (being thermally degaussed) at a lower temperature than a sintered magnet. Furthermore, there were also problems with a sintered magnet in that: a large amount of fluorides to be blended is necessary to promote diffusion reaction; the application to a thick magnetic body (e.g., thickness of more than 10 mm) is difficult; and the concentration of a heavy rare earth element and fluorine decreases from the surface of the magnetic body toward the inside.

Therefore, in order to address the above problems, it is an objective of the present invention to provide a sintered magnet that can reduce the amount of fluorides to be blended to form a reaction phase containing fluorine and enables a diffusion reaction at a low heat treatment temperature. Also, it is another objective of the invention to provide rotating electric machines (motors, generators, and the like) using the sintered magnets.

### Means for Solving the Problems

According to the present invention, there is provided a sintered magnet configured from a magnetic powder containing Nd₂Fe₁₄B as a main component, characterized in that: fluorine, a heavy rare earth element, oxygen and carbon are segregated in some grain-boundary regions of the sintered magnetic powder grains; at each grain-boundary triple junction, concentration of the carbon is higher than that of the fluorine; and concentration of the heavy rare earth element decreases from the grain-boundary triple junction toward inside of the grains of the magnetic powder.

In order to achieve the sintered magnet according to the present invention, the present invention uses a sol-like treatment liquid that is formed by swelling a rare earth fluoride or an alkaline-earth metal fluoride in a solvent containing alcohol as a main component; and adopts a process to impregnate the treatment liquid into a tentative compact (a gap between compression-molded magnetic powders) formed by orienting and compressing the magnetic powders in a magnetic field. Alternatively, the present invention adopts a process of orientation and molding in a magnetic field to be conducted after surface treatment of the unmolded magnetic powders by using the treatment liquid has been finished.

### Advantages of the Invention

According to the present invention, it is possible to uniformly blend a magnetic powder and a fluoride (uniformly coat a surface of a magnetic powder with a fluoride) by the use of a smaller amount of fluorides than those used in the conventional technology that is based on the solid phase reaction by blending powders. Furthermore, it is also possible to lower a heat treatment temperature for the diffusion reaction of the magnetic powder and increase a thickness of the sintered magnet body. As a result, a sintered magnet according to the present invention has a large magnetic anisotropy near the grain-boundary triple junction, thereby increasing thermostability of the magnet as well as reducing the amount of heavy rare earth elements that are rare elements. Since heavy rare earth elements become a factor for reducing residual magnetic flux density of the magnet, reduction of the amount used will increase the energy product, which contributes to the realization of a compact, lightweight magnetic circuit.

### BRIEF DESCRIPTION OF THE DRAWINGS

FIG. 1 is a graph showing a relationship between coercive force and a concentration ratio of carbon/fluorine at the grain-boundary triple junction and a relationship between residual magnetic flux density and the concentration ratio of carbon/fluorine in a sintered magnet according to an embodiment of the present invention.

FIG. 2 is a graph showing a relationship between coercive force and a concentration ratio of oxygen/fluorine at the grain-boundary triple junction and a relationship between residual magnetic flux density and the concentration ratio of oxygen/fluorine in a sintered magnet according to an embodiment of the present invention.

FIG. 3 is a graph showing a relationship between terbium concentration and a distance from a grain boundary of the sintered magnetic powder in a sintered magnet according to an embodiment of the present invention.

FIG. 4 is a graph showing a relationship between carbon concentration and a distance from a grain boundary of the sintered magnetic powder and a relationship between fluorine concentration and the distance from the grain boundary of the sintered magnetic powder in a sintered magnet according to an embodiment of the present invention.

FIG. 5 is a graph showing a relationship between coercive force and a ratio of a segregation width of the rare earth element and a relationship between residual magnetic flux density and the ratio of the segregation width in a sintered magnet according to an embodiment of the present invention.

FIG. 6 is a graph showing a concentration distribution of each element along a depth direction in a sintered magnet according to an embodiment of the present invention.

FIG. 7(1) is an image quality map of a representative electron-beam backscatter pattern in a cross-section perpendicular to a direction of magnetic anisotropy and FIG. 7(2) is a crystal orientation analysis image thereof in a sintered magnet according to Example 7 of the present invention.

FIG. 8 is a chart showing a relationship between temperature and an X-ray diffraction pattern of a Dy—F system film formed from a treatment solution according to an embodiment of the present invention.

### BEST MODE FOR CARRYING OUT THE INVENTION

(1) According to an aspect of the present invention, there is provided a sintered magnet configured from a magnetic powder containing Nd₂Fe₁₄B as a main component, in which: fluorine, a heavy rare earth element, oxygen and carbon are segregated in part of grain-boundary regions of the sintered magnetic powder; at a grain-boundary triple junction, concentration of the carbon is higher than concentration of the fluorine; and concentration of the heavy rare earth element decreases from the grain-boundary triple junction toward an inside of a grain of the sintered magnetic powder.

(2) According to another aspect of the present invention, there is provided a rotating electric machine that uses a sintered magnet configured from a magnetic powder containing Nd₂Fe₁₄B as a main component, in which: in the sintered magnet, fluorine, a heavy rare earth element, oxygen and carbon are segregated in part of grain-boundary regions of the sintered magnetic powder; at a grain-boundary triple junction, concentration of the carbon is higher than concentration of the fluorine; and concentration of the heavy rare earth element decreases from the grain-boundary triple junction toward an inside of a grain of the sintered magnetic powder.

In the above aspects (1) and (2) of the present invention, the following modifications and changes can be made.

(i) A concentration gradient of the heavy rare earth element from the grain-boundary triple junction toward the inside of the sintered magnetic powder grains is larger than the concentration gradient of the heavy rare earth element from the grain-boundary region that connects adjacent grain-boundary triple junctions toward the inside of the sintered magnetic powder grains.

(ii) A segregation width of the heavy rare earth element from the grain-boundary triple junction toward the inside of the sintered magnetic powder grain is larger than the segregation width of the heavy rare earth element from the grain-boundary region that connects adjacent grain-boundary triple junctions toward the inside of the sintered magnetic powder grain. Herein, the segregation width in the present invention is defined as a distance from the grain-boundary (interface) to a location at which the element concentration becomes half of the element concentration on the grin-boundary (interface).

(iii) Continuity of the heavy rare earth element which is segregated along the grain boundary region that connects adjacent grain-boundary triple junctions is higher than continuity of fluorine segregated.

(iv) The heavy rare earth element is dysprosium (Dy).

(3) According to still another aspect of the present invention, there is provided a rotating electric machine that uses a sintered magnet configured from a magnetic powder containing Nd₂Fe₁₄B as a main component, in which: in the sintered magnet, fluorine, a heavy rare earth element, oxygen and carbon are segregated in part of grain-boundary regions of the sintered magnetic powder; the fluorine is contained in an oxyfluoride located in the grain boundary region, and a crystal structure of the oxyfluoride is a cubic crystal or a tetragonal crystal.

In order to realize the sintered magnet according to the present invention and take advantages, there are, for example, two types of techniques (production methods). Both techniques use an alcohol solvent fluoride solution (i.e., the fluoride does not remain in a powder state and light-permeability is ensured; hereafter, sometimes referred to as a treatment solution). One of those techniques is to impregnate a low bulk-density compact (there is a gap between the magnetic powders molded) with a treatment solution before sintering the compact. The other technique is to blend a surface-treated magnetic powder that has beforehand been coated with a treatment solution on the surface thereof with an untreated magnetic powder, tentatively mold the powders, and sinter the compact.

Specific descriptions will be given. For example, when producing a sintered magnet having Nd₂Fe₁₄B as a main phase, the grain size distribution of the magnetic powder is adjusted and then the magnetic powder is tentatively molded in a magnetic field. Because this tentative compact has a gap between magnetic powders, by impregnating the gap with a fluoride solution (treatment solution), it is possible to apply the treatment solution into a core region of the tentative compact. It is desirable that the treatment solution be highly transparent (light permeable, which means a fluoride does not remain in a powder state), and also be a low-viscosity solution. By the use of this kind of solution, it is possible to impregnate every micro gap between magnetic powders with the treatment solution.

Impregnation can be conducted by making a portion of the tentative compact come in contact with the treatment solution, and if there is a gap (opening) of 1 nm to 1 mm on the surface of the tentative compact that has come in contact with the treatment solution, the treatment solution is impregnated by a capillary action along the surface of the magnetic powder in the gap. The direction in which the treatment solution is impregnated is a direction of the continuous through gap of the tentative compact, and to be exact, it depends on a tentative molding condition or a shape of the magnetic powder. Since this method is based on the capillary action, depending on the level of impregnation, a concentration difference may be observed in some elements configuring a fluorine-containing reaction phase after a sintering process is finished. Furthermore, in a direction perpendicular to the surface that has come in contact with the treatment solution, concentration distribution of the reaction phase uniformly containing fluorine is sometimes observed (e.g., when the tentative compact is extremely thick).

The fluoride solution (treatment solution) is an alcohol solution composed of a fluoride containing one or more alkali metal elements, alkaline-earth elements or rare earth elements as well as containing carbon having a structure similar to amorphous substance, or a fluorine oxygen compound further containing oxygen (hereafter, referred to as an oxyfluoride). Impregnation can be conducted at room temperature.

Next, dry heat treatment is applied to the impregnated tentative compact at a temperature from 200 to 400° C. to remove the solvent, and then sintering heat treatment is applied at a temperature from 500 to 800° C. In this sintering heat treatment, treatment solution constituent elements diffuse and react with the magnetic powder, thereby forming a fluorine-containing reaction phase.

Herein, a magnetic powder generally contains 10 to 5000 ppm of oxygen, and light elements or transition metals, such as hydrogen (H), carbon (C), phosphorus (P), silicon (Si), aluminum (Al) and the like, as other impurity elements. Oxygen exists in a magnetic powder not only as a rare earth oxide or an oxide of light elements, such as Si, Al, and the like, but also as a phase containing oxygen having a composition deviated from a stoichiometric composition in the mother phase or the grain boundary region. Such oxides and an oxygen-containing phase reduce magnetization of the magnetic powder and affect a shape of the magnetization curve. This leads to the decrease in the residual magnetic flux density, anisotropy field, squareness of the demagnetization curve, and coercive force, the increase in the irreversible demagnetization and thermal degauss, the fluctuation of magnetization characteristics, the deterioration of corrosion resistance, and the decrease in mechanical characteristics; which results in the decrease in reliability of the magnet. Since oxygen thus affects many magnet characteristics, ingenious attempts have been made so that oxygen does not remain in the magnetic powder.

A treatment solution impregnated along the surface of the magnetic powder generates a fluoride and an oxyfluoride, such as REF₂, REF₃, or REₙ(O,F,C)ₘ (RE represents a rare earth element, and n and m are integers) by the dry heat treatment at a temperature from 200 to 400° C. (some of the solvent components sometimes remain). In an example of the sintering heat treatment, the condition with the degree of atmosphere vacuum of 1×10⁻³ torr or less at a temperature from 400 to 800° C. is maintained for 30 minutes. By the sintering heat treatment, iron, a rare earth element, and oxygen in the magnetic powder diffuse into the fluoride and the oxyfluoride formed on the surface of the magnetic powder, and are trapped on the surface of the REF₃, REF₂, RE(O,F), or RE(O,F,C) grains or in those grains (generating a fluorine-containing reaction phase), thereby reducing oxygen in the grains of the magnetic powder.

Since the treatment solution is impregnated along the gap penetrating from the surface of the tentative compact, a fluorine-containing reaction phase is formed as continuous layers connecting one surface to another in the sintered magnetic body. This means that by impregnating a tentative compact with a treatment solution, it is possible to sinter a magnetic body at relatively low temperature (e.g., 600 to 1000° C.) while generating a fluoride inside the magnetic body.

Furthermore, advantages of the solution impregnating and sintering method are as follows:

A) The amount of fluorides to be blended with a magnetic powder can be reduced.

B) This method can be applied to a thick sintered magnet (e.g., thickness of 10 mm or more).

C) The heat treatment temperature to form a fluorine-containing reaction phase can be made lower.

D) Both the sintering heat treatment and the heat treatment to form a fluorine-containing reaction phase can be simultaneously conducted. A diffusion heat treatment following after the sintering heat treatment conducted in the conventional method that uses powder blending is not necessary.

E) Because a low-viscosity fluoride solution is impregnated into every micro gaps of the tentative compact, some solvent components remain in the micro gaps even during the tentative compact heating process conducted after the treatment solution impregnation process has been finished. This residual solvent is observed as a carbon component in a carbide or a fluoride after the sintering heat treatment has been finished and is segregated in the grain boundary regions and so on. The segregation of the carbon component stabilizes the oxyfluoride having a cubic crystal structure.

According to the above characteristics, the sintered magnet (specifically, thick sintered magnet) has the following significant advantages: increase in residual magnetic flux density and coercive force; improved squareness of the demagnetization curve; improved thermal degauss characteristics; improved magnetization; improved anisotropy; increase in corrosion resistance and mechanical strength; and reduction of losses and production costs.

A fluoride and an oxyfluoride generated by dry heat treatment are formed in layers along the tentatively formed magnetic powder's surface (including a partially discontinuous sheet-like form); however, concentration of the fluorine varies depending on the location of the formed layer. Furthermore, when a magnetic powder is an Nd—Fe—B system substance containing Nd₂Fe₁₄B as the main phase, Nd, Fe, B, an additive element, and an impurity element included in the magnetic powder diffuse into the fluoride and the oxyfluoride formed on the surface of the magnetic powder at a temperature of 200° C. or higher (dry heat treatment to sintering heat treatment).

Herein, in the sintering heat treatment process, the role of carbon and oxygen contained in the fluoride and the oxyfluoride (hereafter, sometimes collectively referred to as a fluoride) becomes important. When concentration of the carbon or the oxygen in a fluoride is low, the fluoride has a low melting point and tends to become a liquid phase, which facilitates the diffusion of constituent elements of the fluoride. On the other hand, when concentration of the carbon or the oxygen in a fluoride is high, in some cases, the fluoride combines with a constituent element diffused from the magnetic powder thereby forming an oxide or a carbide. In this case, because the oxide and the carbide have a high melting point, they do not become a liquid phase and remain as a grain-like or cluster-like solid phase even in the liquid phase of the fluoride having a low melting point.

Therefore, with the progress of the sintering of the magnetic powder, the oxide and the carbide are integrated at the grain-boundary triple junction; as a result, a fluoride containing a large amount of carbon and oxygen is formed at the grain-boundary triple junction after the sintering process has been finished. Further, in the grain-boundary region that connects adjacent grain-boundary triple junctions, constituent elements of the grain-boundary triple junction diffuse and distribute in the grain-boundary region from the grain-boundary triple junction. Herein, the grain-boundary region indicates a boundary face region wherein mother phases are opposed to each other and usually two crystal grains are opposed to each other. Furthermore, the grain-boundary triple junction indicates a location where three crystal grains meet. Usually, at the grain-boundary triple junction, a compound containing much rare earth elements including impurities such as oxygen is formed.

Volume of the fluoride containing carbon and oxygen formed at the grain-boundary triple junction is larger than the volume of the fluoride in the grain boundary region. Since the treatment solution used to form a fluoride on the surface of the magnetic powder uses an alcohol series solvent that contains a large amount of carbon, a large amount of carbon is also included in the fluoride formed. For this reason, concentration of the carbon at the grain-boundary triple junction is higher than the concentration of the carbon in the grain-boundary region. Furthermore, concentration of the fluorine in the grain-boundary region that connects adjacent grain-boundary triple junctions is smaller than the concentration of the fluorine at the grain-boundary triple junction.

From the grain-boundary triple junction and the grain-boundary region toward the inside of the grains of the sintered magnetic powder that is a main phase, concentration gradient of a heavy rare earth element is formed. Because heavy rare earth element concentration at the grain-boundary triple junction is higher than that in the grain-boundary region as described before, the concentration gradient of the heavy rare earth element near the grain-boundary triple junction is larger than the concentration gradient of the heavy rare earth element from the grain-boundary region toward the inside of the grains of the sintered magnetic powder. Furthermore, a width of the concentration gradient of the heavy rare earth element is wider on average near the grain-boundary triple junction than that near the grain-boundary region.

By forming a composition distribution (concentration distribution) as described above, it is possible to inhibit generation of reverse magnetic domain near the grain-boundary triple junction and increase a coercive force without decreasing a residual magnetic flux density.

An Nd—Fe—B system magnetic powder according to the present invention includes a magnetic powder whose main phase contains a phase equivalent to the crystal structure of Nd₂Fe₁₄B, and the main phase may contain a transition metal, such as Al, Co (cobalt), Cu (copper), Ti (titanium), Zr (zirconium), Bi (bismuth) and the like. Furthermore, some of boron may be replaced by carbon. Moreover, a compound such as Fe₃B and Nd₂Fe₂₃B₃, an oxide, a carbide and/or a nitride may be included in a phase other than the main phase.

Because a fluoride layer formed on the surface of the magnetic powder exhibits higher electric resistance at a temperature of 800° C. or lower than the electric resistance of an Nd—Fe—B system magnetic powder, it is possible to increase the electric resistance of the Nd—Fe—B sintered magnet by forming the fluoride layer, which enables the reduction of eddy current loss. Impurities may be included in the fluoride layer as long as those impurities are elements that do not affect magnetic characteristics of the magnet much (e.g., elements that do not exhibit ferromagnetic property at around room temperature). Micro grains of a nitride or a carbide may be blended in the fluoride layer in order to increase electric resistance or improve magnetic characteristics.

In a sintered magnet produced by the solution impregnating and sintering method, the above-mentioned fluoride layers are formed as continuous layers extending from one surface to another surface of the sintered magnet, or a fluoride layer that does not connect to the surface is formed inside the magnetic body (sintered body). This kind of sintered magnet can reduce the amount of heavy rare earth elements to be used, which enables the production of a sintered magnet having a high-energy product and is suitable for high-torque rotating electric machines.

Hereafter, specific descriptions will be given along with the examples of the present invention.

### Example 1

As an Nd—Fe—B system powder, a magnetic powder having an Nd₂Fe₁₄B structure as a main phase is prepared, and a fluoride is formed on a surface of the magnetic powder. For example, when forming DyF₃ on the surface of the magnetic powder, raw material of Dy(CH₃COO)₃ (dysprosium acetate) is dissolved by H₂O (pure water), and HF (hydrofluoric acid) is added. The addition of HF creates gelatinous DyF₃.xH₂O or DyF₃.x(CH₃COO) (x is a positive number). After this is separated by centrifugation to remove the solvent (after solid-liquid separation), an almost equivalent amount of methanol is added to remove anions, thereby obtaining a light-permeable treatment solution. Viscosity of the treatment solution is almost equal to the viscosity of water.

The magnetic powder is put into a die and formed into a tentative compact by applying a load of 1 t/cm² (98 MPa) in a magnetic field of 10 kOe. The tentative compact has a continuous gap (so-called, open pore). Next, a bottom face of the tentative compact is soaked in the light-permeable treatment solution. Herein, the bottom face is the plane that is parallel to the direction of the magnetic field applied when the tentative compact was formed. The treatment solution is impregnated into the magnetic powder's gap from the bottom and side faces of the tentative compact, thereby coating the surface of the magnetic powder with the light-permeable treatment solution.

Next, some of solvent components in the treatment solution coated on the surface of the magnetic powder are evaporated. Because the treatment solution impregnated into micro gaps including micro cracks is light-permeable and has viscosity equivalent to the viscosity of water, the solvent components cannot be completely removed by dry treatment under a reduced pressure of 1 to 10 Pa for 10 minutes, and approximately 5% solvent remains in the micro gaps of the tentative compact. On the other hand, dry treatment with reduced pressure causes hydration water to evaporate, and a fluoride layer is formed on the surface of the magnetic powder. After that, the tentative compact is sintered at approximately 1050° C.

During the sintering heat treatment, Dy, C, O, and F constituting a fluoride layer diffuse along the surface of the magnetic powder and the grain-boundary region, causing mutual diffusion by which those elements are replaced with Nd and Fe that constitute the magnetic powder. Specifically in the grain-boundary region, diffusion (displacement) by which Dy is replaced with Nd progresses, resulting in the formation of the structure in which Dy is segregated along the grain-boundary region. Furthermore, a carbon-containing fluoride (oxyfluoride or fluoride) is formed at the grain-boundary triple junction. Analysis revealed that a carbon-containing fluoride was composed of (Dy,Nd)F₃, (Dy,Nd)F₂, (Dy,Nd)OF, and/or (Dy,Nd)₂O₃.

A 10×10×10-mm³ sintered magnet was produced according to the above procedures, and the cross-section of the sintered magnet was analyzed by a wavelength-dispersive X-ray spectrometer (WDS). A ratio of average fluorine concentration up to a 100 μm depth including the surface of the sintered magnet body to average fluorine concentration in the sintered magnet body core region of a depth of 4 mm or more was measured at ten different locations with an area of 100×100 μm² each; and the result was 1.0±0.5. By analyzing the cross-section of the sintered magnet body by the use of a transmission electron microscope-energy dispersive X-ray analysis (TEM-EDX), it was found that the carbon concentration was higher than the fluorine concentration at the grain-boundary triple junction. Furthermore, by increasing the alcohol concentration of the treatment solution, it was possible to control carbon and oxygen concentration at the grain-boundary triple junction. Moreover, by making the alcohol concentration 10% or more, control was possible so that the carbon concentration became higher than the fluorine concentration at the grain-boundary triple junction.

When comparing with a case that does not use the treatment solution, the coercive force of such a sintered magnet of the present Example increased by 40%, the residual magnetic flux density was reduced by 0 to 1% due to the increase in the coercive force, and Hk (the value of the magnetic field when magnetic flux density is 90% of the residual magnetic flux density) increased by 10%. According to the results, because the sintered magnets produced by the treatment solution impregnating and sintering method have the high energy product, the magnets seem to be suitable for the rotating electric machines for hybrid cars.

### Example 2

As an Nd—Fe—B system powder, a magnetic powder of an average grain size of 5 μm having a main phase of an Nd₂Fe₁₄B structure and an approximately 1%-boride and rare earth rich phase is prepared, and a fluoride is formed on a surface of the magnetic powder. For example, when forming DyF₃ on the surface of the magnetic powder, raw material of Dy(CH₃COO)₃ is dissolved by H₂O, and HF is added. The addition of HF will form gelatinous DyF₃-xH₂O or DyF₃-x(CH₃COO) (x is a positive number). After this is separated by centrifugation to remove the solvent (after solid-liquid separation), an almost equivalent amount of methanol is added to remove anions, thereby obtaining a light-permeable treatment solution. Viscosity of the treatment solution is almost equal to the viscosity of water.

The magnetic powder is put into a die and formed into a tentative compact by applying a load of 0.5 t/cm² in a magnetic field of 5 kOe. Relative density of the tentative compact is approximately 60%, and there is a continuous gap (so-called, open pore) from a bottom face to a top face of the tentative compact. The bottom face of the tentative compact is soaked in the light-permeable treatment solution. Herein, the bottom face is the plane that is parallel to the direction of the magnetic field applied when the tentative compact was formed. The treatment solution is impregnated into the magnetic powder's gap from the bottom and side faces of the tentative compact. At this time, vacuum emission of the tentative compact encourages the light-permeable treatment solution to be actively impregnated into the magnetic powder's gap, and the treatment solution distills from the faces other than the bottom face.

Next, some of solvent components in the treatment solution impregnated in the tentative compact are evaporated. By doing so, hydration water evaporates and a fluoride layer is formed on the surface of the magnetic powder. After that, the tentative compact is sintered by the use of a vacuum heat-treatment furnace at a temperature of approximately 1100° C. maintained for three hours.

During the sintering heat treatment, Dy, C, F, and O constituting a fluoride layer diffuse along the surface of the magnetic powder and the grain-boundary region, causing mutual diffusion by which Nd and Fe constituting the magnetic powder are replaced with Dy, C, and F. Specifically in the grain-boundary region, diffusion (displacement) by which Dy is replaced with Nd progresses, resulting in the formation of the structure in which Dy is segregated along the grain-boundary region. Furthermore, a grain of a fluoride (oxyfluoride or fluoride) formed at the grain-boundary triple junction and in the grain-boundary region is composed of DyF₃, DyF₂, DyOF, NdOF, NdF₂, and/or NdF₃.

Analysis of the fluoride grain by means of a 2 nm-diameter electron-beam by the use of a TEM-EDX revealed that in some fluoride grains, concentration of dysprosium, fluorine, carbon, and oxygen was high from an inside of the grain (grain core region) to a grain boundary (the outer circumferential region of the grain). To be precise, fluorine was detected from the grain core region, and dysprosium concentrated in a region 1 to 100 nm off-site from the grain core region. Within the Dy concentrated region, there was observed a concentration gradient in which Dy concentration decreases from the grain core region toward the outer circumferential region of the grain. This is considered as follows: as the result that Dy atoms originally existing in the grain core region diffused toward the outer circumference of the grain, Dy concentration once decreased from the grain core region toward the outer circumferential region of the grain; thus, concentration distribution in which Dy seems to concentrate in the outer circumferential region of the grain was formed. A concentration ratio of Dy to Nd (i.e., Dy/Nd) in a region approximately 100 nm from the grain core region was 1/2 to 1/10.

Furthermore, both fluorine concentration and carbon concentration at the grain-boundary triple junction of the sintered magnetic powder were higher than those in the grain-boundary region that connects adjacent grain-boundary triple junctions. In most cases, fluorine was detected at the grain-boundary triple junctions of the sintered magnetic powder; however, it was not always detected in the grain-boundary region. Although a concentration gradient of dysprosium was observed from the boundary of the grain of the magnetic powder to the inside of the grain, the concentration gradient near the grain-boundary triple junction was larger than the concentration gradient near the grain-boundary region.

When comparing with the case that does not use the treatment solution, the coercive force of such a sintered magnet of the present Example increased by 40%, the residual magnetic flux density was reduced by 2% due to the increase in the coercive force, and Hk increased by 10%. According to the results, because the sintered magnets produced by the treatment solution impregnating and sintering method have the high energy product, the magnets seem to be suitable for the rotating electric machines for hybrid cars.

### Example 3

A Dy—F system treatment solution was prepared as described below. After dysprosium acetate was dissolved in the water, diluted hydrofluoric acid was gradually added to it. An oxyfluoride and an acid fluorine carbide were blended into the solution where a gel-like fluoride was deposited. The mixed solution was agitated by an ultrasonic agitator, solid and liquid were separated by a centrifuge, and methanol was added to the separated solid phase, thereby obtaining a colloidal methanol solution. After the colloidal methanol solution was fully agitated, anions were removed, thereby making the solution transparent. Herein, anions were removed until the transmission factor of the treatment solution in the visible light became 5% or more.

A tentative compact was prepared as described below. A load of 5 t/cm² was applied to an Nd₂Fe₁₄B magnetic powder in a magnetic field of 10 kOe, thereby forming a tentative compact having a thickness of 20 mm and relative density of 70%. Since relative density of the tentative compact is not 100% (significantly smaller than 100%), a continuous gap (so-called, open pore) always exists in the tentative compact.

Next, a bottom face of the tentative compact which was the face perpendicular to the direction of application of the magnetic field during the compact formation process was come in contact with the treatment solution, and the treatment solution was impregnated into the gap between the magnetic powders of the tentative compact. At this time, vacuum emission encouraged the treatment solution to be easily impregnated along the gap of the magnetic powder to the face opposite to the bottom face. The amount of treatment solution impregnated was approximately 0.1 mass % for the tentative compact.

By conducting a vacuum heat treatment of the impregnated tentative compact at a temperature of 200° C., some of the solvent of the treatment solution was evaporated and dried. In this case, the amount of residual solvent in the tentative compact was approximately 1% of the amount of solvent impregnated during the impregnation process. Next, the dried tentative compact was put in a vacuum heat-treatment furnace and sintered by vacuum heating up to a temperature of 1000° C.; thus, an anisotropy sintered magnet having a relative density of 99% was obtained.

When comparing with a conventional sintered magnet made without the application of impregnation treatment, the sintered magnet treated with impregnation of the Dy—F system treatment solution has characteristics in that dysprosium, fluorine, and carbon were segregated near the grain-boundary triple junction of the sintered magnetic powder in the core region of the sintered magnet body, and a large amount of fluorine, neodymium, and oxygen existed in the grain-boundary region that connected adjacent grain-boundary triple junctions. Thus, in the sintered magnet of the present Example, the Dy near the grain-boundary triple junction increased the coercive force, and the good characteristics of 25 kOe coercive force at 20° C. and 1.5 T residual magnetic flux density were observed.

Concentration of the Dy, C, and F is high in the pathway of impregnation, and those elements diffuse according to the concentration difference. Furthermore, near the surface impregnated with the treatment solution and near the opposed surface thereof, a continuous fluoride layer tends to be formed, while a discontinuous fluoride layer is seen in the vertical direction thereof. In other words, concentration of those elements is high on average near the surface impregnated with the treatment solution and near the opposed surface thereof, and the concentration is low on average in the vertical direction.

Meanwhile, due to the impregnation of the treatment solution, a fluorine-containing reaction phase (fluoride layer) has been formed along the through gap, and the continuous reaction phase has also been formed inside the sintered magnet body. Accordingly, even when the surface of the sintered magnet body was polished, there was not a large difference in the fluorine concentration between the unpolished surface and the new polished surface.

Concentration distribution of each element can be identified by an SEM-EDX (scanning electron microscope-energy dispersive X-ray analysis), a TEM-EDX, an EELS (electron energy-loss spectroscopy), and an EPMA (electron probe microanalyzer). A ratio of average fluorine concentration and a ratio of average carbon concentration were individually analyzed in the magnet body surface region up to the 100-μm depth including the surface of the magnet body and in the core region of the magnet body to the depth of 4 mm or more. Measurement was conducted at ten different locations with an area of 100×100 μm² each. The results indicated that both the ratio of average fluorine concentration and the ratio of average carbon concentration were 1.0±0.5.

The sintered magnet produced by the impregnation of a Dy—F system treatment solution and the sintering heat treatment according to the present Example has one or more of the following advantages: improved squareness of the demagnetization curve; increase in the electric resistance after formation; reduction of temperature dependence of the coercive force and the residual magnetic flux density; increase in the corrosion resistance, mechanical strength, thermal conductivity, and adhesion of the magnet.

Herein, fluorides in the treatment solution other than DyF₃ (dysprosium(III)fluoride) of the Dy—F system are as follows: LiF (lithium fluoride), MgF₂ (magnesium fluoride), CaF₂ (calcium fluoride), ScF₃ (scandium fluoride), VF₂ (vanadium(II)fluoride), VF₃ (vanadium(III)fluoride), CrF₂ (chromium(II)fluoride), CrF₃ (chromium(III)fluoride), MnF₂ (manganese(II)fluoride), MnF₃ (manganese(III)fluoride), FeF₂ (iron(II)fluoride), FeF₃ (iron(III)fluoride), CoF₂ (cobalt(II)fluoride), CoF₃ (cobalt(III)fluoride), NiF₂ (nickel fluoride), ZnF₂ (zinc fluoride), AlF₃ (aluminum fluoride), GaF₃ (gallium fluoride), SrF₂ (strontium fluoride), YF₃ (yttrium fluoride), ZrF₃ (zirconium fluoride), NbF₅ (niobium fluoride), AgF (silver fluoride), InF₃ (indium fluoride), SnF₂ (tin(II)fluoride), SnF₄ (tin(IV)fluoride), BaF₂ (barium fluoride), LaF₂ (lanthanum(II)fluoride), LaF₃ (lanthanum(III)fluoride), CeF₂ (cerium(II)fluoride), CeF₃ (cerium(III)fluoride), PrF₂ (praseodymium(II)fluoride), PrF₃ (praseodymium(III)fluoride), NdF₂ (neodymium(II)fluoride), NdF₃ (neodymium(III)fluoride), SmF₂ (samarium(II)fluoride), SmF₃ (samarium(III)fluoride), EuF₂ (europium(II)fluoride), EuF₃ (europium(III)fluoride), GdF₃ (gadolinium fluoride), TbF₃ (terbium(III)fluoride), TbF₄ (terbium(IV)fluoride), DyF₂ (dysprosium(II)fluoride), HoF₂ (holmium(II)fluoride), HoF₃ (holmium(III)fluoride), ErF₂ (erbium(II)fluoride), ErF₃ (erbium(III)fluoride), TmF₂ (thulium(II)fluoride), TmF₃ (thulium(III)fluoride), YbF₂ (ytterbium(II)fluoride), YbF₃ (ytterbium(III)fluoride), LuF₂ (lutetium(II)fluoride), LuF₃ (lutetium(III)fluoride), PbF₂ (lead fluoride), BiF₃ (bismuth fluoride) or a compound of such a fluoride plus oxygen, carbon, or a transition metal. Furthermore, a solution containing the above fluoride and having visible-light permeability or a solution in which the CH group and a part of fluorine are united can be used as a treatment solution.

### Example 4

A Dy—F system treatment solution was prepared as described below. After dysprosium acetate was dissolved in the water, diluted hydrofluoric acid was gradually added to it. An oxyfluoride and an acid fluorine carbide were blended into the solution where a gel-like fluoride was deposited. The mixed solution was agitated by an ultrasonic agitator, solid and liquid were separated by a centrifuge, and methanol was added to the separated solid phase, thereby obtaining a colloidal methanol solution. After the colloidal methanol solution was fully agitated, anions were removed, thereby making the solution transparent. Herein, anions were removed until the transmission factor of the treatment solution in the visible light became 10% or more.

A tentative compact was prepared as described below. A load of 5 t/cm² was applied to an Nd₂Fe₁₄B magnetic powder having an average aspect ratio of 2 in a magnetic field of 10 kOe, thereby forming a tentative compact having a thickness of 20 mm and relative density of 70%. Since relative density of the tentative compact is not 100% (significantly smaller than 100%), a continuous gap (so-called, open pore) always exists in the tentative compact.

Next, a bottom face of the tentative compact which was the face perpendicular to the direction of application of the magnetic field during the compact formation process was come in contact with the treatment solution, and the treatment solution was impregnated into the gap between the magnetic powders of the tentative compact. At this time, vacuum emission encouraged the treatment solution to be easily impregnated along the gap of the magnetic powder to the face opposite to the bottom face.

By conducting a vacuum heat treatment of the impregnated tentative compact at a temperature of 200° C., some of the solvent of the treatment solution was evaporated and dried. In this case, the amount of residual solvent in the tentative compact was approximately 1% of the amount of solvent impregnated during the impregnation process. Next, the dried tentative compact was put in a vacuum heat-treatment furnace and sintered by vacuum heating up to a temperature of 1000° C.; thus, an anisotropy sintered magnet having a relative density of 99% was obtained.

After the sintering process, distribution of each element was examined. A reaction phase containing Dy, C, O and F was formed so that the phase was segregated from the bottom face to the opposite surface of the sintered magnet body mainly at the grain-boundary triple junction of the sintered magnetic powder, and a size of the phase was 1 to 1000 nm. Furthermore, another reaction phase hardly containing F (the reaction phase containing Dy, C and O) was also widely distributed in the grain-boundary region that connects adjacent grain-boundary triple junctions.

The reason for such distribution of each element was considered as described below. In a treatment solution coated by impregnation, a fluoride and an oxyfluoride are generated on the surface of the magnetic powder by the dry heat treatment. The fluoride and the oxyfluoride tend to become a liquid phase during the sintering heat treatment, while some of them reside in a liquid phase as solid-phase micro grains (containing dysprosium, and carbon or oxygen). Such solid-phase micro grains are integrated at the grain-boundary triple junction with a progress of the sintering of the magnetic powder, and some of them remain in the grain-boundary region. Furthermore, Dy components easily diffuse from the micro grains, while F components do not easily diffuse. Thus, Dy components distribute with a high continuity from the grain-boundary triple junction to the grain-boundary region that connect adjacent grain-boundary triple junctions, while F components tend to remain in the grain-boundary triple junction and the continuity is low.

When comparing with a conventional sintered magnet made without the application of impregnation treatment, the sintered magnet treated with impregnation of the Dy—F system treatment solution has characteristics in that Dy is segregated within a thickness of approximately 500 nm from the grain-boundary triple junction and the grain-boundary region to the inside of the sintered magnetic powder, and a large amount of C, F, Nd, and O exist at the grain-boundary triple junction. Thus, in the sintered magnet of the present Example, the Dy near the grain-boundary triple junction increased the coercive force, and the good characteristics of 30 kOe coercive force at 20° C. and 1.5 T residual magnetic flux density were observed.

A 10×10×10-mm³ sintered magnet was produced according to the above procedures, and the cross-section of the sintered magnet was analyzed by a wavelength-dispersive X-ray spectrometer (WDS). The ratio of average fluorine concentration up to a 100 μm depth including the surface of the sintered magnet body to average fluorine concentration near the sintered magnet body core region of a depth of 4 mm or more was measured at ten different locations with an area of 100×100 μm² each; and the result was 1.0±0.3.

When comparing with the case that does not use the treatment solution, the coercive force of such a sintered magnet of the present Example increased by 40%, the residual magnetic flux density was reduced by 0.1% due to the increase in the coercive force, and Hk increased by 10%. According to the results, because the sintered magnets produced by the treatment solution impregnating and sintering method have the high energy product, the magnets seem to be suitable for the rotating electric machines for hybrid cars. In addition to the above-mentioned improved characteristics, the sintered magnet produced by the impregnation of a Dy—F system treatment solution and the sintering heat treatment according to the present Example has one or more of the following advantages: improved squareness of the demagnetization curve; increase in the electric resistance after formation; reduction of temperature dependence of the coercive force and the residual magnetic flux density; increase in the corrosion resistance, mechanical strength, thermal conductivity, and adhesion of the magnet.

Herein, fluorides in the treatment solution other than DyF₃ of the Dy—F system are as follows: LiF, MgF₂, CaF₂, ScF₃, VF₂, VF₃, CrF₂, CrF₃, MnF₂, MnF₃, FeF₂, FeF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, NdF₃, SMF₂, SmF₃, EuF₂, EuF₃, GdF₃, TbF₃, TbF₄, DyF₂, HoF₂, HoF₃, ErF₂, ErF₃, TmF₂, TmF₃, YbF₂, YbF₃, LuF₂, LuF₃, PbF₂, BiF₃ or a compound of such a fluoride and a transition metal. Furthermore, a solution containing the above fluoride and having visible-light permeability or a solution in which the CH group and a part of fluorine are united can be used as a treatment solution.

### Example 5

A treatment solution to form a rare earth fluoride coating or an alkaline-earth metal fluoride coating was prepared in the following procedures (as an example of Dy).

(5-1) As a salt having good dissolution into the water, 4g of dysprosium acetate was put in 100 mL of water and completely dissolved by the use of a shaker or an ultrasonic agitator.

(5-2) The equivalent amount of 10% diluted hydrofluoric acid that enables a chemical reaction to generate DyFₓ (x=1 to 3) was gradually added.

(5-3) The solution in which gel-like precipitation of DyFₓ (x=1 to 3) had been generated was agitated for one hour or more by the use of an ultrasonic agitator.

(5-4) After the solution was separated by centrifugation at 4,000 to 6,000 rpm, a clear supernatant liquid was removed and the almost equivalent amount of methanol was added.

(5-5) The methanol solution containing the gel-like DyFₓ clusters was agitated to form a completely suspended solution and further agitated by the ultrasonic agitator for one hour or more.

(5-6) The above procedures (5-4) and (5-5) were repeatedly conducted 3 to 10 times until anions, such as an acetate ion, nitrate ion, and the like, were not detected.

(5-7) In the case of the Dy—F system, an almost transparent sol-like DyFₓ solution was obtained. Then, the solution was adjusted so that it became a methanol solution having DyFₓ concentration of 1g/5 mL (=0.2 g/mL).

(5-8) A Cu and Al organometallic compound was added to the solution obtained in procedure (5-7), thereby being prepared a treatment solution.

A treatment solution to form a rare earth fluoride coating other than Dy or an alkaline-earth metal fluoride coating can be made in the almost same procedures as shown above. Herein, the fluoride contained in the treatment solution is not the fluoride or oxyfluoride having a stoichiometric composition indicated by RₙFₘDₗ (R represents a rare earth element or an alkaline-earth element, F represents fluorine, D represents an additive element, and n, m, and 1 are positive numbers).

An X-ray diffraction measurement of the treatment solution or the gel-like film formed by drying the treatment solution was conducted, and it was observed that the obtained X-ray diffraction pattern showed a chart containing a plurality of broad diffraction peaks having a full width at half maximum of 1° or more. This result indicates that an inter-atomic distance between an additive element and fluorine or the inter-atomic distance between atoms of each metal element is not the same as that of the RₙFₘDᵢ having a stoichiometric composition, and the crystal structure is also different from that of the RₙFₘDₗ having a stoichiometric composition.

Furthermore, because the full width at half maximum is 1° or more, the above inter-atomic distance is not constant as an ordinary crystalline body, and there seems to be a certain amount of distribution. The reason for such distribution can be considered because other atoms (e.g., hydrogen, carbon, oxygen, etc.) were disposed around the circumference of the atoms of the above metal element or fluorine. Additional atoms, such as hydrogen, carbon, and oxygen, easily migrate as the result of applied external energy including heat. Consequently, the fluoride structure changes, and liquidity of the treatment solution changes accordingly.

When heating the above treatment solution or the gel-like film formed by drying the treatment solution, it was confirmed that the structure of the fluoride changed, and the diffraction peak of RₙFₘDₗ having a stoichiometric composition or Rₙ(F,O,D)ₘ got to be observed by the X-ray diffraction measurement. The full width at half maximum of the diffraction peak of RₙFₘDₗ having a stoichiometric composition or Rₙ(F,O,D)ₘ was narrower than that of the diffraction peak of the above-mentioned sol-like or gel-like treatment solution.

In order to form a uniform coating on the surface of the magnetic powder by the impregnation of the treatment solution, liquidity of the treatment solution needs to be increased. To do so, it is important for the X-ray diffraction pattern of the treatment solution to have at least one peak having a full width at half maximum of 1° or more. In the treatment solution, the diffraction pattern can contain diffraction peaks of a sub phase including RₙFₘDₗ of a stoichiometric composition or Rₙ(F,O,D)ₘ in addition to diffraction peaks of the main phase having a full width at half maximum of 1° or more. On the other hand, when only a diffraction pattern of RₙFₘDₗ having a stoichiometric composition or Rₙ(F,O,D)ₘ or a diffraction pattern composed of only a peak having a full width at half maximum of less than 1° is observed, liquidity of the treatment solution is inferior and uniform coating is difficult, which is not preferable.

A sintered magnet was fabricated according to the following procedures by the use of the treatment solution prepared as described above:

(5-9) A tentative compact (10×10×10 mm³) having a relative density of 80% was prepared by compression molding an Nd₂Fe₁₄B magnetic powder in a magnetic field. The tentative compact was immersed in the treatment solution prepared as described above, a pressure of the environment of the tentative compact was reduced to 2 to 5 torr, thereby conducting vacuum impregnation of the treatment solution and removal of methanol solvent from the treatment solution.

(5-10) After repeating the vacuum impregnation and the solvent removal in procedure (5-9) one to five times (the amount of residual solvent is approximately 0.5% of the amount immediately after impregnation), the dry heat treatment and the sintering heat treatment were conducted at a temperature ranging from 400 to 1100° C. for 0.5 to 5 hours.

(5-11) A pulse magnetic field of 30 kOe or more was applied to the magnet body sintered in procedure (5-10) along a direction of the magnetic anisotropy, thereby obtaining a sintered magnet.

The demagnetization curve of the magnetized sintered magnet was measured by the use of a DC M-H loop-measuring device. The sintered magnet was disposed between magnetic poles so that the direction of magnetization matches the direction of the field application for the measurement, and then the magnetic field was applied between the magnetic poles. For the pole piece of the magnetic pole to which a magnetic field is applied, an Fe—Co alloy was used, and the value of magnetization was calibrated by using a pure Ni specimen and a pure Fe specimen, having the same shape as the sintered magnet.

According to the measurement result, the coercive force increased in the Nd—Fe—B sintered body wherein a rare earth fluoride coated film was formed on the surface of the magnetic powder. More specifically, in the sintered magnet wherein dysprosium fluorides segregated and the sintered magnet wherein dysprosium oxyfluorides segregated, the coercive force increased by 30% and 20%, respectively, comparing with the case in which the coated film was not formed.

Moreover, by the use of a treatment solution in which nearly 0.001 mass % of Cu, Mn, and/or Ga have been added to a fluoride solution, the following advantages can be obtained:

a) Interface energy is reduced as the result of the segregation near the grain boundary.

b) Lattice match at the grain boundary is increased.

c) Defect along the grain boundary is reduced.

d) Grain-boundary diffusion of rare earth elements and so on is promoted.

e) Magnetic anisotropy energy near the grain boundary is increased.

f) The interface with a fluoride or an oxyfluoride is smoothed.

g) Anisotropy energy in the grain boundary region is increased.

h) Unevenness of the interface that comes in contact with the mother phase is reduced.

Consequently, the sintered magnet produced by the impregnation and coating of a treatment solution to which an additive element has been added and the application of sintering heat treatment has one or more of the following advantages: increase in the coercive force, squareness of the demagnetization curve, residual magnetic flux density, energy product, and the Curie temperature; reduction of a magnetization magnetic field, temperature dependence of the coercive force and the residual magnetic flux density; increase in the corrosion resistance and the electric resistance; and reduction of the thermal degauss ratio.

Additive elements tend to segregate in the grain-boundary phase (reaction phase by the treatment solution) between magnetic powders in a sintered magnet, at the end of the grain boundary region, or near the grain boundary inside the magnetic powder (the outer circumference of the sintered magnetic powder). Furthermore, concentration of the additive elements tends to decrease on average from the outer circumference of the sintered magnetic powder toward the inside, i.e., the concentration tends to become high at the grain-boundary portion. A width of the segregation near the grain-boundary triple junction tends to be different from the width of segregation near the grain-boundary region that connect adjacent grain-boundary triple junctions, and the width of segregation near the grain-boundary triple junction tends to be wider than that near the grain-boundary region.

Other than Cu, Mn, and Ga, additive elements that can be added to the treatment solution and were considered effective for increasing the above magnetic characteristics of the sintered magnet are as follows: Mg, Al, Si, Ca, Ti, V, Cr, Fe, Co, Ni, Zn, Ge, Sr, Zr, Nb, Mo, Pd (palladium), Ag, In, Sn, Hf (hafnium), Ta (tantalum), W (tungsten), Ir (iridium), Pt (platinum), Au (gold), Pb, Bi and elements selected from atomic numbers 18 to 86 containing all transition metals. In the sintered magnetic powder, if the concentration gradient of at least one element of those and the concentration gradient of fluorine are observed, the coercive force of the sintered magnet increases.

Because additive elements added to the treatment solution diffuse as the result of the heating after the impregnation coating process, their distribution is different from the distribution of the elements that have been added to the magnetic powder beforehand. For example, concentration of the additive elements is high in the region where fluorine segregates (i.e., the grain-boundary triple junction and the grain-boundary region), and distribution of elements added beforehand is observed in the region where little fluorine segregates (e.g., a distance of nearly 1000 nm from a center of the grain-boundary region toward the inside of the grain of the magnetic powder). Furthermore, when concentration of the additive elements in the treatment solution is low, the state can be detected from a concentration gradient or a concentration difference only near the grain-boundary triple junction.

The sintered magnet having improved characteristics produced by the use of a treatment solution to which additive elements have been added exhibits the following characteristics:

1) A concentration gradient or a concentration difference of elements having atomic numbers from 18 to 86 containing a transition metal can be observed from the topmost surface of the crystal grain of the sintered magnet (sintered magnetic powder) toward the inside thereof.

2) Elements having atomic numbers from 18 to 86 containing a transition metal segregated near the grain boundary tend to accompany fluorine in many regions.

3) Segregation of elements having atom numbers from 18 to 86 containing a transition metal can be observed near the region wherein there is a fluorine concentration difference (e.g., the inside and outside of the fluorine-containing grain-boundary phase).

4) At least one of elements constituting the treatment solution has a concentration gradient from the surface of the sintered magnetic powder toward the inside thereof, and the fluorine-containing grain-boundary phase contains oxygen or carbon.

Thus, an additive element, such as Cu, Al, and so on, and at least one of the elements having atomic numbers from 18 to 86 are detected from the fluorine-containing grain-boundary phase. In other words, the additive elements are mostly contained along the treatment solution impregnation pathway inside the sintered magnet body. Furthermore, a sintered magnet produced by the use of a treatment solution to which an additive element has been added has one or more of the following advantages: increase in the coercive force, squareness of the demagnetization curve, the residual magnetic flux density, energy product, and the Curie temperature; reduction of a magnetization field and the temperature dependence of the coercive force and the residual magnetic flux density; increase in the corrosion resistance and the electric resistance; and reduction of the thermal degauss ratio.

Concentration of the above additive element can be confirmed by analyzing crystal grains of the sintered body by the use of a TEM-EDX, an EPMA, or an ICP-AES (inductively-coupled plasma atomic emission spectroscopy). Analysis by the TEM-EDX and the EELS verified that elements having atomic numbers from 18 to 86 added to the solution segregated near the fluorine atom (within nearly 2000 nm from where fluorine segregated, more prominently, within 1000 nm). Such composition analysis results revealed that when sintering a tentative compact into which a Dy—F system treatment solution was vacuum-impregnated at 200 Pa, a highly continuous segregation layer was formed along the impregnation pathway, and fluorine formed a grain-like oxyfluoride containing carbon at the grain-boundary triple junction. Furthermore, a carbon-containing fluoride or oxyfluoride mainly formed at the grain-boundary triple junction was discontinuous, while a rare-earth-containing phase diffused and generated from the fluoride or the oxyfluoride was highly continuous.

Moreover, it was found that a carbon-containing grain-like oxyfluoride had a higher concentration of carbon or oxygen than the concentration of fluorine. This was considered because increase in carbon concentration or oxygen concentration generated a fluoride having a high melting point, which remained as a solid phase in a liquid phase and was integrated into the grain-boundary triple junction (high concentration at the grain-boundary triple junction). On the other hand, it was considered that elements other than fluorine diffused from the solid phase (fluoride having a high melting point) into the grain-boundary region that connects adjacent grain-boundary triple junctions and the inside of the grain of the magnetic powder during the sintering heat treatment, thereby forming a highly continuous segregation layer.

### Example 6

As an Nd—Fe—B system powder, an (Nd,Dy)—Fe—B system magnetic powder having an Nd₂Fe₁₀ structure and containing 2 mass % of Dy was prepared, and a fluoride was formed on a surface of the magnetic powder. For example, when forming TbF₃ on the surface of the magnetic powder, raw material of Tb(CH₃COO)₃ is dissolved by H₂O, and HF is added. The addition of HF will create gelatinous TbF₃-xH₂O or TbF₃-x(CH₃COO) (x is a positive number). After this is separated by centrifugation to remove the solvent (after solid-liquid separation), an almost equivalent amount of methanol is added to remove anions, thereby obtaining a light-permeable, low-viscosity treatment solution. Viscosity of the treatment solution is almost equal to the viscosity of water.

The magnetic powder is put into a die and formed into a tentative compact by applying a load of 1 t/cm² in a magnetic field of 10 kOe. The tentative compact has a continuous gap (so-called, open pore). Next, a bottom face of the tentative compact is soaked in the light-permeable treatment solution. Herein, the bottom face is the plane that is parallel to the direction of the magnetic field applied when the tentative compact was formed. The treatment solution is impregnated into the magnetic powder's gap from the bottom and side faces of the tentative compact, thereby coating the surface of the magnetic powder with the light-permeable treatment solution.

Next, the dry treatment process is conducted in which solvent components of the treatment solution coated on the surface of the magnetic powder are evaporated in a vacuum so that the amount of residual solvent components in the tentative compact is approximately 0.2% of the amount immediately after impregnation. This dry treatment evaporates hydration water and so on, and a fluoride layer is formed on the surface of the magnetic powder. After that, the tentative compact is sintered at approximately 1050° C.

During the sintering heat treatment, Tb, C, O, and F constituting a fluoride layer diffuse along the surface of the magnetic powder and the grain-boundary region, causing mutual diffusion by which those components are replaced with Nd and Fe constituting the magnetic powder. Specifically in the grain-boundary region, diffusion (displacement) by which Tb is replaced with Nd progresses, resulting in the formation of the structure in which Tb is segregated along the grain-boundary region. Furthermore, a carbon-containing fluoride (oxyfluoride or fluoride) is formed at the grain-boundary triple junction. Analysis revealed that a carbon-containing fluoride was composed of (Tb,Nd)F₃, (Tb,Nd)F₂, (Tb,Nd)OF, and/or (Tb,Nd)₂O₃.

A 10×10×10-mm³ sintered magnet was produced according to the above procedures, and the cross-section of the sintered magnet was analyzed by a wavelength-dispersive X-ray spectrometer (WDS). A ratio of average fluorine concentration up to a 100 μm depth including the surface of the sintered magnet body to average fluorine concentration in the sintered magnet body core region of a depth of 4 mm or more was measured at ten different locations with an area of 100×100 μm² each; and the result was 1.0±0.5.

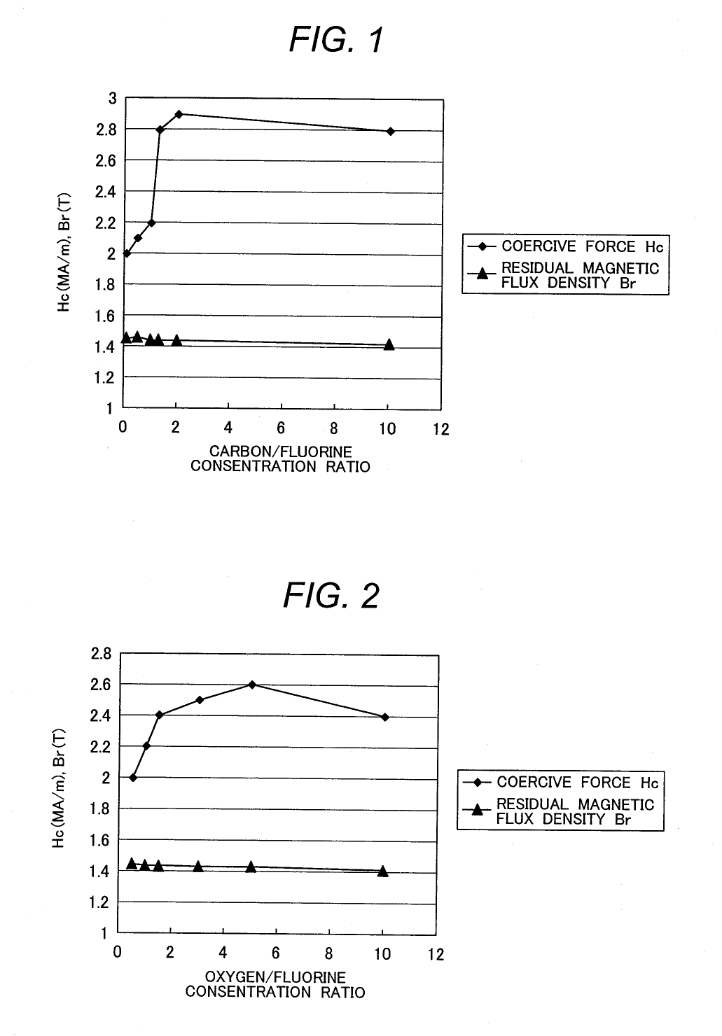

As the ratio of carbon concentration to fluorine concentration at the grain-boundary triple junction becomes large, the coercive force of the sintered magnet also increases. This seems to be because the increase in the carbon concentration inhibits the diffusion of Tb into the grain of the magnetic powder during the sintering heat treatment, and the diffusion of Tb can be limited only along the grain boundary region. FIG. 1 is a graph showing a relationship between the coercive force (Hc) and the concentration ratio of carbon/fluorine at the grain-boundary triple junction and a relationship between the residual magnetic flux density (Br) and the concentration ratio of carbon/fluorine in a sintered magnet according to an embodiment of the present invention. As shown in FIG. 1, the coercive force (Hc) tends to become large as the carbon concentration becomes high. Specifically, when the carbon concentration becomes higher than the fluorine concentration, the coercive force significantly increases. On the other hand, the residual magnetic flux density (Br) do not change much even when the carbon concentration became high.

By controlling concentration of oxygen contained in the alcohol solvent of the treatment solution or controlling the dry condition after the surface of the magnetic powder has been coated with the treatment solution, it is possible to control a concentration ratio of oxygen/fluorine at the grain-boundary triple junction. FIG. 2 is a graph showing a relationship between the coercive force and the concentration ratio of oxygen/fluorine at the grain-boundary triple junction and a relationship between the residual magnetic flux density and the concentration ratio of oxygen/fluorine in a sintered magnet according to an embodiment of the present invention. Herein, the concentration ratio of carbon/fluorine at the grain-boundary triple junction was controlled so that the ratio became approximately 1. As shown in FIG. 2, the coercive force increases as the oxygen concentration increases, while the coercive force tends to decrease when the concentration ratio of oxygen/fluorine exceeds 6. Since oxygen, in the same manner as carbon, is considered to increase the melting point of a fluoride, inhibit Tb from diffusing into the grain of the magnetic powder, and limit the diffusion only along the grain boundary region, it is desirable that oxygen having a concentration higher than the fluorine concentration be contained in a fluoride. On the other hand, it was verified that the presence of oxygen slightly decreased the residual magnetic flux density, however, as long as oxygen concentration is within 1000 times of fluorine concentration, the effect of the increased coercive force can be maintained.

As shown in FIG. 1 and FIG. 2, it was verified that in a fluorine-containing compound located at the grain-boundary triple junction, when the carbon concentration is higher than the fluorine concentration and/or the oxygen concentration is higher than the fluorine concentration, the coercive force is increased while high residual magnetic flux density is maintained.

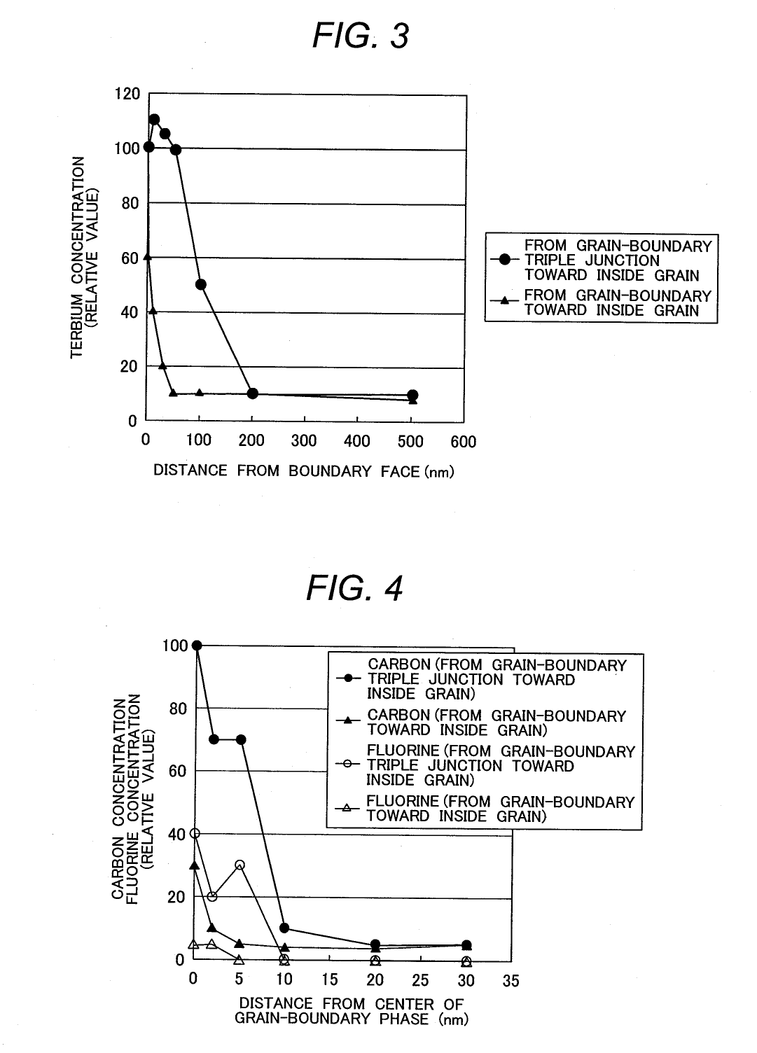

Typically, with respect to the concentration distribution of Tb from the grain boundary of the sintered magnetic powder, which is a mother phase, toward the inside of the grain, distribution from the grain-boundary triple junction toward the inside of the grain of the sintered magnetic powder is different from the distribution from the grain-boundary region that connects adjacent grain-boundary triple junctions toward the inside of the grain of the sintered magnetic powder. The Tb concentration and a distance from the grain boundary of the sintered magnetic powder (that is, distribution of Tb concentration) were measured by a TEM-EDX and results are shown in FIG. 3. FIG. 3 is a graph showing a relationship between the Tb concentration and the distance from the grain boundary of the sintered magnetic powder in a sintered magnet according to an embodiment of the present invention. As shown in FIG. 3, the Tb concentration originating from the grain-boundary triple junction is higher than the Tb concentration originating from the grain-boundary region that connects adjacent grain-boundary triple junctions (sometimes simply referred to as a grain boundary). In either case, the Tb concentration tends to decrease from the boundary face of the sintered magnetic powder toward the inside of the grain, however, in the distribution of the Tb concentration originating the grain-boundary triple junction, there was a region wherein the Tb concentration once increased within the grain (the region wherein Tb concentration becomes higher than the Tb concentration at the boundary face). Furthermore, when a distance from the boundary face to a location at which an element concentration becomes half of the concentration of the element at the boundary face is defined as a segregation width, it was found that the segregation width of Tb from the grain-boundary triple junction was broader than that from the grain-boundary region.

FIG. 4 is a graph showing a relationship between the carbon concentration and a distance from the grain boundary of the sintered magnetic powder and a relationship between the fluorine concentration and the distance from the grain boundary of the sintered magnetic powder in a sintered magnet according to an embodiment of the present invention. When originating from the grain-boundary triple junction, a good amount of Tb was detected at a location 100 nm from the boundary face (see FIG. 3). On the other hand, as shown in FIG. 4, the segregation widths of carbon and fluorine were extremely narrow. Specifically, it was verified that fluorine distributed in the grain-boundary phase or at the grain-boundary triple junction, and solid solution of fluorine was hardly detected within the grain of the mother phase (sintered magnetic powder). Herein, fluorine located in the grain of the sintered magnetic powder existed as a fluoride containing a rare earth element in the form of micro grains significantly smaller than the crystal grains of the mother phase.

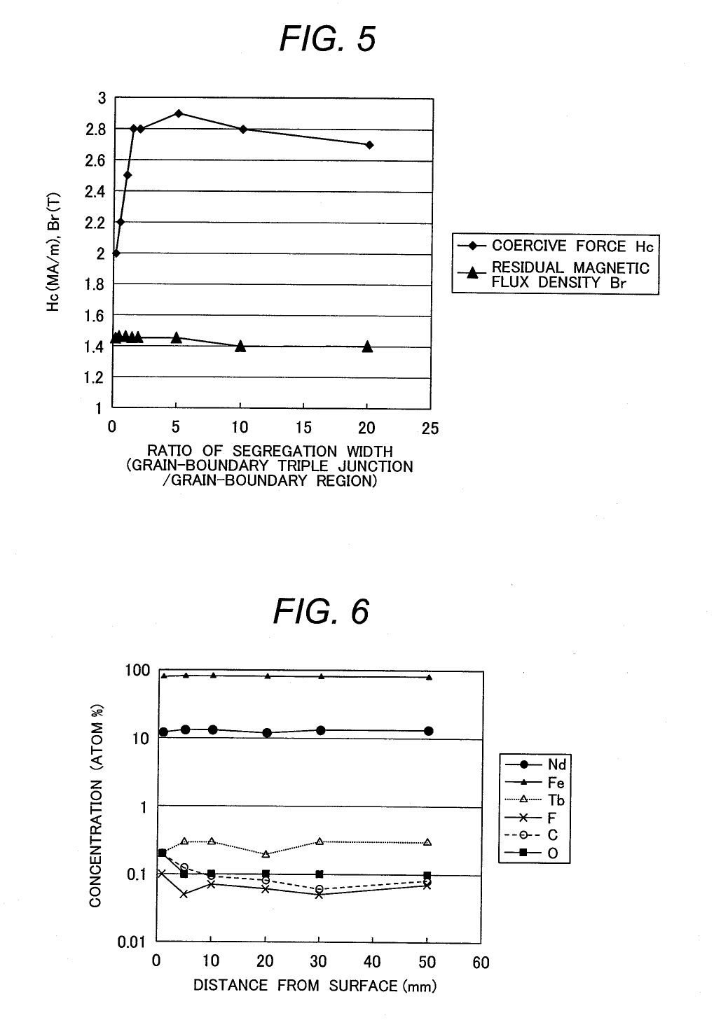

FIG. 5 is a graph showing a relationship between the coercive force and a ratio of the segregation width of the rare earth element and a relationship between the residual magnetic flux density and the ratio of the segregation width in a sintered magnet according to an embodiment of the present invention. Herein, the ratio of the segregation width is defined as a ratio of the segregation width originating from the grain-boundary triple junction to that originating from the grain boundary region (“segregation width originating from grain-boundary triple junction”/“segregation width originating from grain boundary region”). FIG. 5 indicates that the coercive force (Hc) of the sintered magnet increases with increasing the ratio of the segregation width of the grain-boundary triple junction to that of the grain boundary region increases (with becoming broader the segregation width of Tb originating from the grain-boundary triple junction). Specifically, the coercive force was high in the range where the ratio of the segregation width was 2 to 20. Furthermore, within this range, the residual magnetic flux density (Br) did not decrease much.

The above-mentioned heavy rare earth element segregation condition or composition distribution can be realized with respect to Dy, Ho, and Pr other than Tb, and it is possible to make a coercive force high without decreasing the residual magnetic flux density. Furthermore, because sintered magnets according to the present invention produced by the impregnation of a fluoride treatment solution using an alcohol series solvent and the sintering treatment have the high energy product, the magnets are considered suitable for the rotating electric machines for hybrid cars.

### Example 7

As an Nd—Fe—B system powder, an (Nd,Dy)—Fe—B system magnetic powder having an Nd₂Fe₁₄B structure and containing 2.5 mass % of Dy was prepared, and a fluoride was formed on a surface of the magnetic powder. For example, when forming TbF₃ on the surface of the magnetic powder, raw material of Tb(CH₃COO)₃ is dissolved by H₂O, and HF is added. The addition of HF will create gelatinous TbF₃-xH₂O or TbF₃-x(CH₃COO) (x is a positive number). After this is separated by centrifugation to remove the solvent (after solid-liquid separation), an almost equivalent amount of methanol is added to remove anions, thereby obtaining a light-permeable, low-viscosity treatment solution. Viscosity of the treatment solution is almost equal to the viscosity of water.

The magnetic powder is put into a die and formed into a tentative compact by applying a load of 1 t/cm² in a magnetic field of 10 kOe. The tentative compact has a continuous gap (so-called, open pore). A bottom face of the tentative compact is soaked in the light-permeable treatment solution. Herein, the bottom face is the plane that is parallel to the direction of the magnetic field applied when the tentative compact was formed. The treatment solution is impregnated into the magnetic powder's gap from the bottom and side faces of the tentative compact, thereby coating the surface of the magnetic powder with the light-permeable treatment solution.

Next, dry treatment process is conducted in which solvent components of the treatment solution coated on the surface of the magnetic powder is evaporated in a vacuum such that the amount of residual solvent components in the tentative compact is approximately 0.1% of the amount immediately after impregnation. This dry treatment evaporates hydration water and so on, and a carbon-containing oxyfluoride layer is formed on the surface of the magnetic powder. After that, the tentative compact is sintered at approximately 1050° C. by the use of a vacuum heat treatment furnace.

During the sintering heat treatment, Tb, C, O, and F constituting a fluoride layer diffuse along the grain-boundary region of the magnetic powder via a liquid phase, causing mutual diffusion by which those components are replaced with Nd and Fe constituting the magnetic powder. Specifically near the grain-boundary triple junction, diffusion (displacement) by which Tb is replaced with Nd or Dy progresses, resulting in the formation of the structure in which Tb is segregated along the grain-boundary region. Furthermore, a carbon-containing fluoride (oxyfluoride or fluoride) and an oxide are formed at the grain-boundary triple junction. Analysis revealed that a carbon-containing fluoride is composed of (Tb,Nd)F₃, (Tb,Nd)F₂, (Tb,Nd)OF, and/or (Tb,Nd)₂O₃.

A 100×100×100-mm³ sintered magnet was produced according to the above procedures, and the cross-section of the sintered magnet was analyzed by a wavelength-dispersive X-ray spectrometer (WDS). A ratio of average fluorine concentration up to a 100 μm depth including the surface of the sintered magnet body to average fluorine concentration in the sintered magnet body core region of a depth of 4 mm or more was measured at ten different locations with an area of 100×100 μm² each; and the result was 1.0±0.5.

Concentration distribution of elements constituting a sintered body (sintered magnet) along a depth direction was measured by an EDX and an EELS and the results are shown in FIG. 6. FIG. 6 is a graph showing the concentration distribution of each element along the depth direction in a sintered magnet according to an embodiment of the present invention. Herein, the concentration of each element was an average value in an area of 1×1 mm². As shown in FIG. 6, the carbon concentration was higher than the fluorine concentration, and the oxygen concentration was also higher than the fluorine concentration. Thus, as the result of the segregation of carbon and oxygen having a higher concentration than the fluorine concentration, Tb was segregated at the grain-boundary triple junction and along the grain-boundary region, thereby obtaining a sintered magnet having a high coercive force of 2.5 MA/m or more.

Furthermore, as a ratio of the carbon concentration to the fluorine concentration at the grain-boundary triple junction became higher, the coercive force of the sintered magnet increased. This seems to be because the increase in the carbon concentration inhibits the diffusion of Tb into the grain of the magnetic powder during the sintering heat treatment, and the diffusion of Tb could be limited only along the grain boundary region.

### Example 8

Description will be given about an example of a method of producing an RE-Fe—B system (RE represents a rare earth element) sintered magnet having a composition indicated by the following chemical formula (1) or chemical formula (2).

REₐG_{b}T_{c}A_{d}FₑO_{f}M_{g} Chemical formula (1)

(RE,G)_{a+b}T_{c}A_{d}FₑO_{f}M_{g} Chemical formula (2)

Herein, “RE” represents one or more elements selected from rare earth elements.

“M” represents an element that exists in the tentative compact before the treatment solution containing fluorine (F) is coated and is an element of group 2 to group 16 except for a rare earth element, boron (B), and carbon (C).

“G” represents one or more elements selected from both metal elements and rare earth elements, or one or more elements selected from both metal elements and alkaline-earth metal elements. Herein, the metal element is defined as a group 3 to group 11 metal element except for a rare earth element, or a group 2 or group 12 to group 16 element except for boron (B) and carbon (C). When “RE” and “G” do not contain the same element, composition of the sintered magnet is expressed by chemical formula (1). Furthermore, “RE” and “G” can have the same element, and when “RE” and “G” contain the same element, composition of the sintered magnet is expressed by chemical formula (2).

“T” represents iron (Fe) and/or cobalt (Co).

“A” represents boron (B) and/or carbon (C).

“F” represents fluorine, and “O” represents oxygen.

Letters “a” to “g” represent atomic % of an alloy. In chemical formula (1), “10≦a≦15”, “0.005≦b≦2”. In chemical formula (2), “10.005≦a+b≦17”. Furthermore, in both chemical formulas (1) and (2), “3≦d≦17”, “0.01≦e≦10”, “0.04≦f≦4”, “0.01≦g≦11”, and the remaining portion is “c”.

Moreover, the above sintered magnet has the following characteristics. Fluorine (F) and at least one kind of metal elements which are constituent elements of a sintered magnet distributes so that its concentration becomes high on average from a core region of a crystal grain (sintered magnetic powder) constituting the magnet toward a grain boundary located on the outer circumference side of the crystal grain. A concentration ratio of G and RE “G/(RE+G)” contained at the grain-boundary triple junction around the main phase crystal grain composed of (RE,G)₂T₁₄A tetragonal crystal in the sintered magnet is higher on average than the concentration ratio “G/(RE+G)” in the main phase crystal grain. Concentration gradient of RE and G exists in at least 1-μm region from the outer edge boundary face of the main phase crystal grain (the grain-boundary triple junction and the grain boundary region that connects adjacent grain-boundary triple junctions) toward the inside of the crystal grain. Furthermore, the concentration gradient originating from the grain-boundary triple junction is larger than the concentration gradient originating from the grain boundary region that connects adjacent grain-boundary triple junctions. In the sintered magnet, a carbon concentration or an oxygen concentration is higher than the fluorine concentration.

A treatment solution to form a rare earth fluoride coating to which a metal element was added or to form an alkaline-earth metal fluoride coating film was prepared in the following procedures (as an example of Dy).

(8-1) As a salt having good dissolution into the water, 1 to 10g of dysprosium acetate or dysprosium nitrate was put in 100 mL of water and completely dissolved by the use of a shaker or an ultrasonic agitator.

(8-2) The equivalent amount of 10% diluted hydrofluoric acid that enables a chemical reaction to generate DyFₓ (x=1 to 3) was gradually added.

(8-3) The solution in which gel-like precipitation of DyFₓ (x=1 to 3) had been generated was agitated for one hour or more by the use of an ultrasonic agitator.

(8-4) After the solution was separated by centrifugation at 4,000 to 10,000 rpm, a clear supernatant liquid was removed and the almost equivalent amount of methanol was added.

(8-5) The methanol solution containing the gel-like Dy—F system, Dy—F—C system, or Dy—F—O system clusters was agitated to form a completely suspended solution and further agitated by the ultrasonic agitator for one hour or more.

(8-6) The above procedures (8-4) and (8-5) were repeatedly conducted 3 to 10 times until anions, such as an acetate ion, nitrate ion, and the like, were not detected.

(8-7) In the case of the Dy—F system, an almost transparent sol-like DyFₓ solution containing C or O was obtained. Then, the solution was adjusted so that it became a methanol solution having DyFₓ concentration of 1 g/5 mL (=0.2 g/mL).

(8-8) An organometallic compound containing at least one kind of metal element was added to the solution obtained in procedure (8-7), thereby being prepared a treatment solution.

A treatment solution to form a rare earth fluoride coating other than Dy, an alkaline-earth metal fluoride coating, or a group 2 metal fluoride coating can be made in the almost same procedures as shown above. The fluoride contained in a treatment solution made by adding a variety of metal elements to a fluoride solution containing a rare earth element, alkaline-earth element, or a group 2 metal element (e.g., Dy, Nd, La, Mg and so on) is not a fluoride or oxyfluoride having a stoichiometric composition expressed by RₙFₘ (R represents a rare earth element, group 2 metal element, or an alkaline-earth element, F represents fluorine, and n and m are positive numbers) or RₙFₘOₚCᵣ (O represents oxygen, C represents carbon, and n, m, p, and r are positive numbers).

An X-ray diffraction measurement of the treatment solution or the gel-like film formed by drying the treatment solution was conducted, and it was observed that the obtained X-ray diffraction chart showed a diffraction pattern having a broad diffraction peak with a full width at half maximum of 1° or more as a main peak. This result indicates that an inter-atomic distance between an additive element and fluorine or the inter-atomic distance between atoms of each metal element is not the same as that of the RₙFₘ having a stoichiometric composition, and the crystal structure is also different from that of the RₙFₘ having a stoichiometric composition.

Furthermore, because the full width at half maximum is 1° or more, the above inter-atomic distance is not constant as an ordinary crystalline body, and there seems to be a certain amount of distribution. The reason for such distribution can be considered because other atoms (e.g., hydrogen, carbon, oxygen, etc.) were disposed around the circumference of the atoms of the above metal element or fluorine. Additional atoms, such as hydrogen, carbon, and oxygen, easily migrate as the result of applied external energy including heat. Consequently, the fluoride structure changes, and liquidity of the treatment solution changes accordingly.

When heating the above treatment solution or the gel-like film formed by drying the treatment solution, it was confirmed that the structure of the fluoride changed, and the diffraction peak of RₙFₘ having a stoichiometric composition, Rₙ(F,C,O)ₘ, or Rₙ(F,O)ₘ got to be observed by the X-ray diffraction measurement. The full width at half maximum of the diffraction peak of RₙFₘ having a stoichiometric composition, Rₙ(F,C,O)ₘ, or Rₙ(F,O)ₘ was narrower than that of the diffraction peak of the above-mentioned sol-like or gel-like treatment solution.

In order to form a uniform coating on the surface of the magnetic powder by the impregnation of the treatment solution, liquidity of the treatment solution needs to be increased. In order to equalize the coating, it is important for the X-ray diffraction pattern of the treatment solution to have at least one peak having a full width at half maximum of 1° or more.

A sintered magnet was fabricated according to the following procedures by the use of the treatment solution prepared as described above:

(8-9) A tentative compact (100×100×100 mm³) was prepared by compression molding an Nd—Fe—B system magnetic powder in a magnetic field. The tentative compact was immersed in the treatment solution prepared as described above, a pressure of the environment of the tentative compact was reduced to 2 to 5 torr, thereby conducting vacuum impregnation of the treatment solution and removal of methanol solvent from the treatment solution. The amount of residual solvent in the tentative compact was approximately 0.2% of the solvent before it was removed.

(8-10) After repeating the vacuum impregnation and the solvent removal in process (8-9) one to five times, the dry heat treatment and the sintering heat treatment were conducted at temperature ranging from 400 to 1100° C. for 0.5 to 5 hours.

(8-11) A pulse magnetic field of 30 kOe or more was applied to the magnet body sintered in process (8-10) along a direction of the magnetic anisotropy, thereby obtaining a sintered magnet.

The demagnetization curve of the magnetized sintered magnet was measured by the use of a DC M-H loop-measuring device. The sintered magnet was disposed between magnetic poles so that the direction of magnetization matches the direction of the field application for the measurement, and then the magnetic field was applied between the magnetic poles. For the pole piece of the magnetic pole to which a magnetic field is applied, an Fe—Co alloy was used, and the value of magnetization was calibrated by using a pure Ni specimen and a pure Fe specimen, having the same shape as the sintered magnet.

According to the measurement result, the coercive force increased in the Nd—Fe—B sintered body in which a rare earth fluoride coated film was formed on the surface of the magnetic powder. More specifically, in a rare earth sintered magnet produced by the use of a treatment solution to which a metal element was added, the coercive force or the squareness of the demagnetization curve further increased when compared with the case that used a treatment solution to which no metal element was added. Furthermore, analysis was conducted by the use of a TEM-EDX or an SEM-EDX. The ratio of average fluorine concentration or average carbon concentration up to a 100 μm depth including the surface of the sintered magnet body to the average concentration in the sintered magnet body core region of a depth 4 mm or more was measured at ten different locations with an area of 100×100 μm² each; and the result was 1±0.5.

The fact that the rare earth sintered magnet fabricated by the use of a treatment solution to which metal elements have been added has an increased coercive force and improved squareness of the demagnetization curve means that those additive elements have contributed to the improvement of the magnetic characteristics. The factors will be discussed below. It can be considered that a short-range structure was formed near the metal elements added to the treatment solution due to the removal of the solvent, and that the metal elements diffused together with other treatment solution constituent elements along the grain boundary of the sintered magnetic powder during the sintering heat treatment. Some metal elements added to the treatment solution segregated together with some of other treatment solution constituent elements near the grain boundary of the sintered magnetic powder. In the composition distribution of the sintered magnet having a high coercive force, the treatment solution constituent elements showed high concentration in the outer circumferential portion of the sintered magnetic powder and low concentration in the core region of the sintered magnetic powder. Furthermore, from the outer circumferential portion of the sintered magnetic powder toward the core region thereof, there was a concentration gradient or a concentration difference of fluorine and at least one kind of metal element. This seems to be because a treatment solution containing additive elements was impregnated into a tentative compact having a continuous gap, and the surface of the magnetic powder was coated with the treatment solution and dried, thereby forming a fluoride or oxyfluoride containing additive elements and having a short range structure; thus, diffusion of the fluoride or oxyfluoride progressed along the grain boundary as the sintering heat treatment progressed.

Meanwhile, even when a sintered magnet is produced by the conventional production method which uses powder blending (e.g., the method of blending an alloy powder for sintered magnets and a fluoride powder, wherein a metal element has been added to the fluoride powder), a higher coercive force can be obtained than the coercive force obtained when a metal element was not added; thus, better magnetic characteristics are ensured. Furthermore, when a sintered magnet is produced by a production method in which a film containing a heavy rare earth element such as Dy is formed on a surface of a tentative compact by means of vapor deposition or sputtering, the magnet produced by the vapor deposition or sputtering of a deposition source or a target with which a metal element has been blended has better magnetic characteristics than the magnet made without blending a metal element.

On the contrary, the magnet produced by the production method according to the present invention in which a metal element (e.g., transition metal and semimetal element) is added to a light-permeable treatment solution has a greater coercive force and much improved magnetic characteristics. This seems to be because metal elements (e.g., transition element and semimetal element) are uniformly blended on an atomic level in the treatment solution, and the metal elements having a short range structure are uniformly dispersed even in a fluoride film formed by drying; consequently, the added metal elements can diffuse together with other treatment solution constituent elements along the grain boundary of the sintered magnetic powder at a lower temperature.

Added metal elements (group 3 to group 11 metal elements except for rare earth elements; or group 2, group 12 to group 16 elements except for boron (B) and carbon (C)) have one or more of the following functional effects.

a) Thermal stability of the grain-boundary phase is increased as the result of the segregation near the grain boundary.

b) Lattice match of the grain boundary is improved.

c) Defect around the grain boundary is reduced.

d) Diffusion of rare earth elements into the grain of the sintered magnetic powder is inhibited and diffusion along the grain boundary is promoted.

e) Magnetic anisotropy energy near the grain boundary is increased.

f) The boundary face with a fluoride, oxyfluoride, or a fluoride carbonate is smoothed.

g) Anisotropy of rare earth elements is increased.

h) Oxygen is removed from the mother phase (magnetic powder).

i) The Curie temperature of the mother phase (magnetic powder) is increased.

j) The amount of rare earth elements to be used can be reduced. For example, when compared on the basis of the same coercive force, the use of an additive element can reduce the amount of heavy rare earth elements to be used by 50% to 90%.

k) An oxyfluoride or fluoride containing an additive element with a thickness of 1 to 10,000 nm is formed on a surface of the sintered magnetic powder, thereby contributing to the increase in corrosion resistance or electric resistance.

l) Segregation of an element that has been added to a magnetic powder beforehand is promoted.

m) Oxygen in the mother phase is diffused to the grain boundary, thereby exerting a reduction action, or an additive element combines with oxygen in the mother phase, thereby reducing the mother phase.

n) Regularization of the grain-boundary phase is promoted. Some additive elements remain in the grain-boundary phase.

o) Growth of a fluorine-containing phase at the grain-boundary triple junction is inhibited.

p) The concentration gradient of a heavy rare earth element or fluorine near the grain-boundary triple junction or near the grain boundary is made steep.

q) Diffusion of fluorine, carbon, oxygen, or an additive element decreases the liquid phase forming temperature near the grain boundary.

r) Magnetic moment of the mother phase is increased due to grain-boundary segregation of fluorine or an additive element.

s) Temperature at which heavy rare earth elements diffuse along the grain boundary can be promoted to decrease, and the growth of an undesirable phase that decreases residual magnetic flux density (e.g., the phase highly containing rare earth elements other than the mother phase and a boride, etc.) can be inhibited.

Consequently, the sintered magnet produced by the impregnation and coating of a treatment solution to which a metal element has been added and the application of sintering heat treatment according to the present Example has one or more of the following advantages: increase in a coercive force, squareness of the demagnetization curve, residual magnetic flux density, energy product, and the Curie temperature; reduction of a magnetization magnetic field, temperature dependence of the coercive force and the residual magnetic flux density; increase in the corrosion resistance and the electric resistance; and reduction of the thermal degauss ratio. The sintered magnet is suitable for the magnet disposed on the outer circumference side of the rotor in a motor.

### Example 9

An Nd₂Fe₁₄B magnetic powder having a grain size of 0.5 to 10 μm was prepared. By blending a neodymium-fluoride-containing treatment solution with the magnetic powder and drying the mixture, a fluoride-containing film (average film thickness was 0.1 to 2 nm) was formed on a surface of the magnetic powder.

An oxyfluoride or a fluoride (wherein amorphous substances and crystalline substances (e.g., rhombohedral crystal) coexist) is generated in the fluoride-containing film, and the structure of the oxyfluoride or the fluoride is changed by heat treatment. For example, when heated in the air, a neodymium-containing oxyfluoride was generated in the film. Furthermore, the X-ray diffraction measurement verified that the crystal structure of the oxyfluoride was changed from a rhombohedral crystal to a cubic crystal by the increase in temperature (temperature ranging from 500 to 700° C.)

The magnetic powder on which a fluoride-containing film was formed on the surface thereof was put into a die disposed in a molding apparatus to which a magnetic field could be applied. A tentative compact was made by applying a load of 1 to 3 t/cm² in a magnetic field of 5 kOe or more.

Next, the tentative compact was heated in a vacuum and then sintered. The sintering temperature was 1050° C., and the liquid phase sintering was conducted in which a liquid phase originating from a fluoride-containing film was formed in the tentative compact. After the sintering heat treatment, an aging heat treatment was conducted by reheating at 550° C. and then rapidly cooling.

Some fluorides before the aging heat treatment react with oxygen contained in a magnetic powder to become an oxyfluoride (Nd—O—F). The oxyfluoride before the aging heat treatment contains a large amount of crystals having a structure other than a cubic crystal (e.g., rhombohedral crystal). Therefore, in the aging heat treatment, to generate more cubic crystals than rhombohedral crystals, it is desirable that the oxyfluoride be heated and maintained at temperature higher than the temperature at which the oxyfluoride transforms from a rhombohedral crystal to a cubic crystal and then cooled rapidly. This aging heat treatment enables the cubic crystal that is a high-temperature stable phase to be maintained at room temperature; accordingly, the crystal structure of the oxyfluoride near the grain boundary mainly becomes a cubic crystal. As a result of the aging heat treatment, at the grain-boundary triple junction of the sintered magnetic powder, segregation of oxygen, fluorine, and carbon that constitute a cubic crystal oxyfluoride was observed.

By properly controlling the aging heat treatment temperature range, the content percentage of cubic crystals can be increased, thereby increasing a coercive force of the sintered magnet. It is desirable that the aging temperature be higher than the temperature at which a rhombohedral crystal transforms to a cubic crystal. For example, it is necessary to maintain the temperature higher than the exothermic peak temperature obtained by a differential thermal analysis of the oxyfluoride. On the other hand, when cooling, it is desirable that cooling be conducted at around the exothermic peak temperature with a rate of 10° C./min or faster. By doing so, it is possible to inhibit transformation into a crystal having a different structure from the cubic crystal including the rhombohedral crystal.

Magnetic characteristics of the sintered magnet produced according to the above procedures by the use of a treatment solution having a neodymium fluoride of 0.1 mass % were: the residual magnetic flux density was 1.4 T and the coercive force was 30 kOe. On the other hand, in comparison, magnetic characteristics of the sintered magnet made without using a treatment solution were: the residual magnetic flux density was 1.4 T and the coercive force was 20 kOe.

### Example 10

An arbitrary shaped Nd₂Fe₁₄B magnetic powder having a tetragonal crystal structure with a grain size of 0.5 to 10 μm was prepared. By blending a neodymium-fluoride-containing treatment solution having an alcohol solvent with the magnetic powder and drying the mixture, a fluoride-containing film (average film thickness was 1 to 5 nm) was formed on a surface of the magnetic powder.

An oxyfluoride or a fluoride (wherein amorphous substances and crystalline substances (e.g., rhombohedral crystal) coexist) and an oxide are generated in the fluoride-containing film, and the structure of the oxyfluoride or the fluoride is easily changed by heat treatment at temperature of 350° C. to remove the solvent. For example, when heated in an Ar gas atmosphere, a neodymium-containing oxyfluoride is partially generated in the film. Furthermore, the X-ray diffraction measurement verified that the crystal structure of the oxyfluoride was changed from the rhombohedral crystal to the cubic crystal by the increase in temperature (temperature ranging from 500 to 700° C.). The size of the crystal grain of the oxyfluoride increased with heating, and it was 1 to 10 nm at 500° C. Herein, an oxyfluoride is a compound expressed by NdₙOₘFₗ (n, m, and 1 are positive integers); and an oxide is a compound expressed by MₓO_{y} (x and y are positive integers).

The magnetic powder on which a fluoride-containing film was thus formed on the surface thereof was put into a die disposed in a molding apparatus to which a magnetic field could be applied. The magnetic powder coated with a film in which the oxyfluoride would grow with heating was put into a die and formed into a tentative compact by applying a load of 0.5 t/cm² in a magnetic field of 5 kOe or more.

Next, the tentative compact was heated in a vacuum and then sintered. The sintering temperature was 1030° C., and the liquid phase sintering was conducted such that a liquid phase containing a fluoride or an oxyfluoride was formed in the tentative compact. After the sintering heat treatment, an aging heat treatment was conducted by reheating at 580° C. and then rapidly cooling at a cooling rate of 10° C./min or faster.

Some fluorides before the aging heat treatment react with oxygen contained in the magnetic powder or oxygen in the coating film to become an oxyfluoride (Nd—O—F). The crystal structure of the oxyfluoride before the aging heat treatment contains a large amount of crystals having a structure other than a cubic crystal (e.g., rhombohedral crystal). Therefore, in the aging heat treatment, to generate more cubic crystals than rhombohedral crystals, it is desirable that the oxyfluoride be heated and maintained at temperature higher than the temperature at which the oxyfluoride transforms from a rhombohedral crystal to a cubic crystal and then cooled rapidly. This aging heat treatment enables the cubic crystal that is a high-temperature stable phase (stable at high temperature in terms of free energy) to be maintained at room temperature; accordingly, the crystal structure of the oxyfluoride near the grain boundary mainly becomes a cubic crystal. As a result of the aging heat treatment, at the grain-boundary triple junction of the sintered magnetic powder, segregation of oxygen, fluorine, and/or carbon that constitute a cubic crystal oxyfluoride was observed.

When the oxyfluoride contains carbon or nitrogen included in the treatment solution, the optimal aging heat treatment condition is almost the same. Furthermore, if some other rare earth elements or iron atoms partially diffuses into the oxyfluoride during the sintering heat treatment, magnetic characteristics of the sintered magnet after the aging heat treatment do not change much.

The lattice constant of the cubic crystal oxyfluoride increases as a temperature increases. The unit cell volume of the cubic crystal oxyfluoride is 150 to 210 Å³ (0.15 to 0.21 nm³). By properly controlling the aging heat treatment temperature range, it is possible to increase content percentage of the cubic crystal; accordingly, lattice matching to an Nd₂Fe₁₄B crystal that is the main phase of the sintered magnetic powder can be improved. Furthermore, by properly controlling the value of the lattice constant of the oxyfluoride, it is possible to make the average lattice strain to the mother phase (Nd₂Fe₁₄B) 1 to 10%. Moreover, it is possible to localize various additive elements, such as Cu, Ga, Zr, etc., in the grain boundary region. When a structure of the cubic crystal is a face-centered cubic lattice, the coercive force of the sintered magnet is increased by 5 to 20 kOe.

It is desirable that the aging temperature be higher than the temperature at which a rhombohedral crystal transforms to a cubic crystal. For example, it is necessary to maintain the temperature higher (e.g., approximately 10° C.) than the exothermic peak temperature obtained by a differential thermal analysis of the oxyfluoride. On the other hand, when cooling, it is desirable that cooling be conducted at around the exothermic peak temperature with a rate of at least 5° C./min (preferably, 10° C./min or more). By doing so, it is possible to inhibit transformation into a crystal having a different structure from the cubic crystal including the rhombohedral crystal.

Magnetic characteristics of the sintered magnet produced according to the above procedures by the use of a treatment solution having a neodymium fluoride of 0.1 mass % were: the residual magnetic flux density was 1.5 T and the coercive force was 30 kOe. On the other hand, in comparison, magnetic characteristics of the sintered magnet made without using a treatment solution were: the residual magnetic flux density was 1.5 T and the coercive force was 20 kOe. In this Example, the case that uses a neodymium fluoride is described. However, it was separately verified that the use of another fluoride also made it possible to inhibit the decrease in residual magnetic flux density of the sintered magnet and increase the coercive force. The fluoride was a fluoride containing a rare earth element, an alkali metal element, and an alkaline-earth element.

### Example 11

By pulverizing an Nd₂Fe₁₄B magnetic powder having a main structure of tetragonal crystal, a magnetic powder having a grain size of 0.1 to 7 μm was prepared. The Cu, Al, Ag, Au, Ga, or Zr element of 0.01 to 1 mass % was added to the Nd₂Fe₁₄B magnetic powder. By blending the magnetic powder with a Dy(F,O)₃ treatment solution (using an alcohol solvent) containing fluorine and oxygen and by drying the mixture, an oxyfluoride film (average film thickness of 1 to 2 nm) mainly having an amorphous structure was formed on a surface of the magnetic powder.

Due to the additive element added to the Nd₂Fe₁₄B magnetic powder, when heat treatment is conducted at temperature from 300 to 900° C., an oxyfluoride having a cubic crystal structure is easy to grow between the oxyfluoride film and the main phase (magnetic powder). This is because some of the above additive elements are segregated near the grain boundary of the magnetic powder, thereby increasing lattice match at the interface between the cubic crystal oxyfluoride and the main phase as well as increasing the stability of the cubic crystal.

The additive-element-containing Nd₂Fe₁₄B magnetic powder on which the above-mentioned oxyfluoride film (further containing approximately 0.1 atom % of carbon) was formed on the surface thereof was put into a die disposed in a molding apparatus to which a magnetic field could be applied. After compression molding was finished in a magnetic field, a sintering heat treatment was conducted at a temperature of 1050° C.

In some cases during the sintering heat treatment, some of the oxyfluoride crystals have a different crystal structure from the cubic crystal. A crystal having a rhombohedral crystal structure or a hexagonal crystal structure has bad lattice matching to the main phase of the magnetic powder and becomes a cause of the decrease in a coercive force of the sintered magnet. Therefore, it is desirable that those crystals should not be generated. One of effective methods to make the volume of the oxyfluoride crystals having a crystal structure other than the cubic crystal smaller than the volume of the oxyfluoride crystals having a cubic crystal structure is to add the above-mentioned additive element and to control the aging heat treatment temperature and cooling rate.

Specifically, in the aging heat treatment, it is desirable that an oxyfluoride crystal be heated to a temperature at which the cubic crystal structure thereof becomes stable, and then cooled rapidly. When an oxyfluoride is a Dy—(O,F) system, by heating to 600° C. and then rapidly cooling the temperature range from 600 to 550° C. at a rate of 10° C./min or more, it is possible to transform an oxyfluoride having a structure other than the cubic crystal to a cubic crystal oxyfluoride and to stabilize the crystal structure.

The sintered magnet subject to the above aging heat treatment had a 5 kOe higher coercive force than the sintered magnet subject to the aging heat treatment at the maximum temperature of 550° C. Furthermore, as the result that the crystal structure of the oxyfluoride changed from a rhombohedral crystal to a cubic crystal thereby increasing lattice matching to the main phase of the magnetic powder, in the sintered magnet subject to the above aging heat treatment, the residual magnetic flux density was the same and the coercive force was increased by 5 to 10 kOe when compared with the sintered magnet which was not subject to the aging heat treatment. Magnetic characteristics of the Nd₂Fe₁₄B sintered magnet produced according to the above procedures were: the residual magnetic flux density was 1.4 T and the coercive force was 30 kOe.

The amount of rare earth elements used to produce a sintered magnet according to the present Example was successfully reduced when compared with a sintered magnet produced according to the conventional technology (a sintered magnet produced by a powder blending method). Furthermore, composition analysis revealed that oxygen, fluorine, and/or carbon constituting a cubic crystal oxyfluoride were segregated at the grain-boundary triple junction of the sintered magnetic powder. Moreover, it was separately verified that as a cubic crystal oxyfluoride that can increase the coercive force, oxyfluorides containing a rare earth element other than Dy, an alkali metal element, or an alkaline-earth metal element could be used.

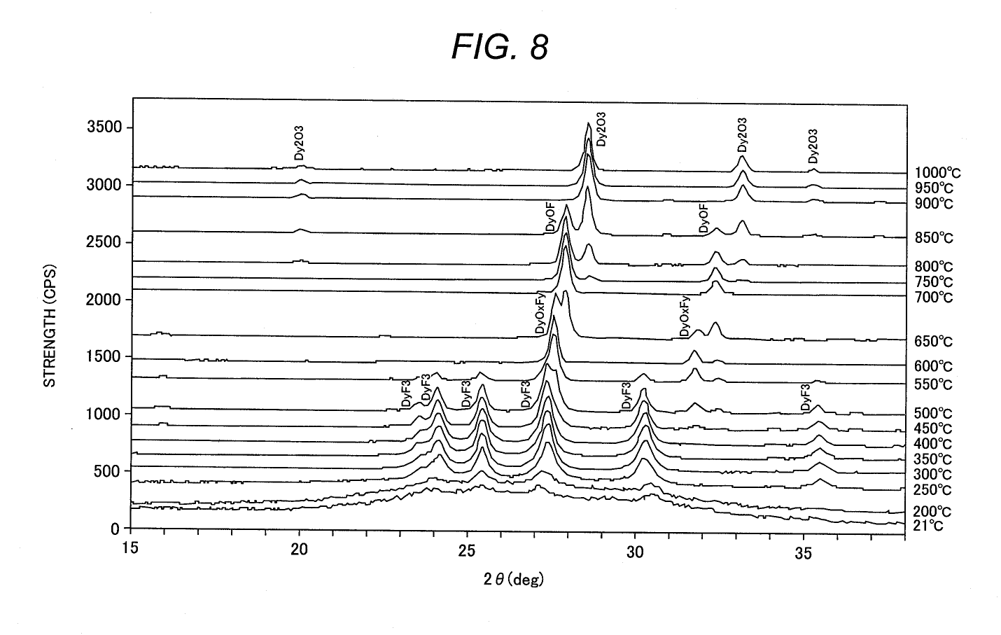

The crystal structure of the oxyfluoride changes at temperature ranging from 300 to 1000° C. When sintering heat treatment or aging heat treatment is not properly conducted, a large number of crystals which are not cubic crystals grow near the grain-boundary triple junction of the sintered body and near the grain boundary region that connect adjacent grain-boundary triple junctions. FIG. 8 is a chart showing a relationship between temperature and an X-ray diffraction pattern of a Dy—F system film formed from a treatment solution according to an embodiment of the present invention. The X-ray diffraction measurement was conducted by a conventional 2θ/θ measurement by using a CuKα ray.

As shown in FIG. 8, at 21° C. and 200° C., the diffraction pattern is a broad diffraction pattern like a hollow pattern as a whole, however, a weak diffraction peak that is considered originating from DyF₃ was observed. The broad pattern (hollow pattern) almost completely vanished at temperature from 300 to 350° C., and the DyF₃ peak became clear with a rise in temperature. When temperature became 500 to 550° C., an oxyfluoride crystal began to generate in place of DyF₃; at 650° C., cubic crystal Dy—O—F began to be detected; and at 700° C., the structure reached almost a single phase of cubic crystal. Moreover, at 650° C. or lower, weak diffraction peaks were observed near 20=16° and near 20=22 to 23°, which indicated the existence of a long-period structure.

The above-described evaluation of crystal structure change due to temperature revealed the following: when a Dy—F system treatment solution is applied to an Nd—Fe—B system magnetic powder, it is desirable that the aging heat treatment temperature be 550° C. or higher at which cubic crystal Dy—O—F generates and grows and be 700° C. or lower at which Dy₂O₃ is hard to generate (i.e., the temperature ranging from 550 to 700° C.). Specifically, it is indicated that by conducting the aging heat treatment at temperature ranging from 550 to 650° C. at which Dy—O—F shows a long-period structure, it is possible to increase lattice matching to the mother phase of the sintered magnetic powder.

### Example 12

By pulverizing an Nd₂Fe₁₄B magnetic powder having a main structure of tetragonal crystal, a magnetic powder having a grain size of 0.1 to 7 μm was prepared. The Cu, Al, Ag, Au, Ga, or Zr element of 0.01 to 1 percent by mass was added to the Nd₂Fe₁₄B magnetic powder. By immersing the pulverized magnetic powder in a fluorine-containing NdF₃ solution without exposing the magnetic powder to the air and by drying the mixture, a fluoride film (with an average film thickness of 1 to 2 nm) mainly having an amorphous structure was formed on a surface of the magnetic powder.

Due to the additive element added to the Nd₂Fe₁₄B magnetic powder, when heat treatment is conducted at temperature from 300 to 700° C., an oxygen-containing fluoride having a cubic crystal structure is easy to grow between the fluoride film and the main phase (magnetic powder). This is because some of the above additive elements are segregated near the grain boundary of the magnetic powder, thereby increasing lattice match at the interface between the cubic crystal or tetragonal crystal oxyfluoride and the main phase as well as increasing the stability of the cubic crystal or tetragonal crystal.

The additive-element-containing Nd₂Fe₁₄B magnetic powder on which the above-mentioned oxyfluoride film was formed on the surface thereof was put into a die disposed in a molding apparatus to which a magnetic field could be applied. After compression molding was finished in a magnetic field, a sintering heat treatment was conducted at a temperature of 1050° C.

When avoiding the exposure to the air until the sintering heat treatment process is finished, a fluoride in the film combines with oxygen contained in the magnetic powder to form an oxyfluoride. The oxyfluoride sometimes contains nearly 5 ppm of carbon or nitrogen, however, it does not affect sintering properties or magnetic characteristics of the sintered magnet.

In some cases during the sintering heat treatment, some of the oxyfluoride crystals have a different crystal structure from the cubic crystal or tetragonal crystal. A crystal having a rhombohedral crystal structure or a hexagonal crystal structure has bad lattice matching to the main phase of the magnetic powder and becomes a cause of the decrease in a coercive force of the sintered magnet. Therefore, it is desirable that those crystals should not be generated. One of effective methods to make the volume of the oxyfluoride crystals having a crystal structure other than the cubic crystal or tetragonal crystal smaller than the volume of the oxyfluoride crystals having a cubic crystal or tetragonal crystal structure is to add the above-mentioned additive element and to control the aging heat treatment temperature and cooling rate.

Specifically, in the aging heat treatment, it is desirable that an oxyfluoride crystal be heated to a temperature at which the cubic crystal structure or tetragonal crystal structure thereof becomes stable, and then cooled rapidly. Although the temperature at which the cubic crystal or tetragonal crystal structure becomes stable depends on a composition of the oxyfluoride and a condition of the interface, the temperature is nearly within a range from 550 to 650° C. For example, when an oxyfluoride is (Nd,Fe)—(O,F), by heating to 600° C. and then rapidly cooling the temperature range from 600 to 550° C. at a rate of 10° C./min or more, it is possible to transform an oxyfluoride having a structure other than cubic crystal to a cubic crystal oxyfluoride and to stabilize the crystal structure. It is preferable that the Fe content in (Nd,Fe)—(O,F) be within a range from 0.01 to 1 atom %, however, even when the Fe is not contained, the coercive force of the sintered magnet can be increased.

The sintered magnet subject to the above aging heat treatment (e.g., 570° C.) had a 5 kOe higher coercive force than the sintered magnet that was not subject to the aging heat treatment. Furthermore, as the result that the crystal structure of the oxyfluoride changed from a rhombohedral crystal to a cubic crystal or tetragonal crystal thereby increasing lattice matching to the main phase of the magnetic powder, and an effect was further added due to the segregation of a small amount of additive elements near the grain boundary of the magnetic powder; in the above-mentioned sintered magnet, the residual magnetic flux density was the same and the coercive force was increased by 5 to 15 kOe when compared with the sintered magnet which did not contain additive elements.

Herein, typical elements that are segregated are Cu, Al, Ag, Au, Ga, Zr or rare earth elements other than Nd. Specifically, since aluminum easily combines with fluorine, it tends to form a fluoride or an oxyfluoride in the grain boundary region of the sintered magnetic powder and inside the grain. Thus, increase in the coercive force due to the increase in the area of the interface was confirmed. Magnetic characteristics of the Nd₂Fe₁₄B sintered magnet produced according to the above procedures were: the residual magnetic flux density was 1.45 T and the coercive force was 30 kOe.

The amount of rare earth elements used to produce a sintered magnet according to the present Example was successfully reduced when compared with a sintered magnet produced according to the conventional technology (a sintered magnet produced by a powder blending method). Furthermore, composition analysis revealed that oxygen, fluorine, and/or carbon constituting a cubic crystal oxyfluoride were segregated at the grain-boundary triple junction of the sintered magnetic powder. Moreover, it was separately verified that as a cubic crystal oxyfluoride that can increase the coercive force, oxyfluorides containing a rare earth element other than Nd, an alkali metal element, or an alkaline-earth metal element could be used.

The crystal structure of the oxyfluoride changes at temperature ranging from 300 to 1000° C. When sintering heat treatment or aging heat treatment is not properly conducted, a large number of crystals which are not cubic crystals grow near the grain-boundary triple junction of the sintered body and near the grain boundary region that connect adjacent grain-boundary triple junctions. On the other hand, by properly conducting the aging heat treatment, a volume ratio of the oxyfluoride having a cubic crystal or a tetragonal crystal, which is a distorted cubic crystal, can be made higher than the volume ratio of the oxyfluoride having another structure in the sintered body. As a result, it is possible to increase the coercive force of a sintered magnet by 1 to 5 kOe.

Because an oxyfluoride having a cubic crystal or a tetragonal crystal that is a distorted cubic crystal has high lattice matching to the main phase of the magnetic powder, the oxyfluoride increases magnetic anisotropy of the main phase of the magnetic powder, reduces interface energy, eliminates a reverse magnetic domain generating site, and promotes segregation of trace additive elements on the coherent interface, which contributes to the increase in the coercive force of the sintered magnet. Furthermore, due to the continuous growth of the oxyfluoride from the grain-boundary triple junction of the sintered magnetic powder along the grain boundary, stability of a cubic crystal or a tetragonal crystal (a distorted cubic crystal) structure of the main phase is increased, generation of the reverse magnetic domain is inhibited, thus the coercive force is increased.

Lattice matching of an oxyfluoride to the main phase of a magnetic powder can be evaluated by analyzing electron-beam diffraction images and lattice images. From the analysis of the diffraction and lattice images, was recognized a specific crystal orientation relationship between the oxyfluoride and the main phase. In the above-mentioned cubic crystal or tetragonal crystal, the crystal lattices were slightly distorted due to matching strain, and intervals between crystal planes of a specific orientation were contracted or elongated. The contraction (elongation) ratio was 0.1 to 10%. While such the lattice strain was larger near the interface, it was smaller in the core region of the grain-boundary triple junction. Furthermore, it seemed that the lattice strain depended on compositions of the oxyfluoride or the main phase of a magnetic powder, and that it depended on concentration of the trace additive elements segregated near the coherent interface by a heat treatment.

Table 1 shows measurement and analysis results of the sintered magnets according to the above-mentioned Examples (Examples 1 to 12): type of heavy rare earth element segregated near the grain-boundary of the sintered magnetic powder, concentration gradient from the grain-boundary triple junction of the sintered magnetic powder toward the inside of the grain, concentration gradient from the grain-boundary region that connect adjacent grain-boundary triple junctions toward the inside of the grain, segregation width from the grain-boundary triple junction to the inside of the grain, and segregation width from the grain-boundary region that connect adjacent grain-boundary triple junctions toward the inside of the grain. Herein, a TEM-EDX was used for the measurement and analysis, and values shown in Table 1 are average values calculated from the mapping images by regarding the maximum detected concentration of segregated heavy rare earth element as 100% and defining the distance from the grain-boundary face in units of nm (nanometer).

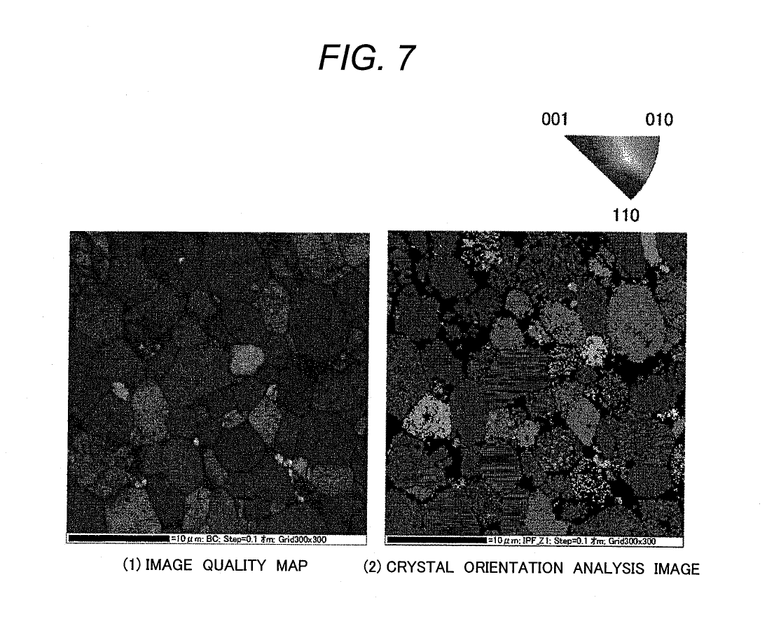

FIG. 7(1) is an image quality map of a representative electron-beam backscatter pattern in a cross-section perpendicular to a direction of magnetic anisotropy and FIG. 7(2) is a crystal orientation analysis image thereof in a sintered magnet according to Example 7 of the present invention. In the image quality map of FIG. 7(1), the black line like a grain boundary observed between crystal grains indicates that there is a phase having a crystal structure other than the crystal structure of the mother phase of the magnetic powder. Furthermore, this black line is also recognized in the crystal orientation analysis image shown in FIG. 7(2), which indicates that the black line is a different phase from the mother phase of the magnetic powder. It was verified that this phase on the black line different from the mother phase of the magnetic powder mainly has a cubic crystal structure, was formed in layers around the grain of the sintered magnetic powder, and contained fluorine and oxygen. Moreover, according to the crystal orientation analysis image of FIG. 7(2), with respect to the crystal orientation of the main phase of the magnetic powder, it was verified that 50% to 97% of crystal grains were aligned along the crystal direction of 001.

TABLE 1

| | | | Concentration | | |
|---|---|---|---|---|---|
| | | | gradient from | | Segregation |
| | | | grain-boundary | | width from |
| | | | region | | grain-boundary |
| | | Concentration | connecting | Segregation | connecting |
| | | gradient from | adjacent grain- | width from | adjacent grain- |
| | | grain-boundary | boundary triple | grain-boundary | boundary triple |
| | Segregated | triple junction | junctions | triple junction | junctions |
| | heavy rare | toward inside of | toward inside | toward inside | toward inside |
| | earth element | grain | of grain | of grain | of grain |
| Example 1 | Dy | 0.2%/nm | 5%/nm | 40 nm | 150 nm |
| Example 2 | Dy | 0.4%/nm | 3%/nm | 70 nm | 300 nm |
| Example 3 | Dy | 0.3%/nm | 5%/nm | 40 nm | 150 nm |
| Example 4 | Dy | 0.5%/nm | 5%/nm | 40 nm | 150 nm |
| Example 5 | Dy | 0.4%/nm | 4%/nm | 40 nm | 150 nm |
| Example 6 | Tb | 0.5%/nm | 1%/nm | 50 nm | 200 nm |
| Example 7 | Tb | 1%/nm | 2%/nm | 80 nm | 500 nm |
| Example 8 | Dy | 2%/nm | 3%/nm | 100 nm | 500 nm |
| Example 9 | Nd | 0.1%/nm | 0.4%/nm | 10 nm | 20 nm |
| Example 10 | Nd | 0.2%/nm | 0.3%/nm | 10 nm | 15 nm |
| Example 11 | Dy | 0.1%/nm | 0.2%/nm | 5 nm | 10 nm |
| Example 12 | Nd | 0.1%/nm | 0.2%/nm | 5 nm | 300 nm |

1. A sintered magnet configured from a magnetic powder grain having Nd₂Fe₁₄B as a main component, wherein:
fluorine, a heavy rare earth element, oxygen, and carbon are segregated in part of grain-boundary regions of the sintered magnetic powder grains;
concentration of the carbon is higher than concentration of the fluorine at a grain-boundary triple junction of the grain-boundary region; and
concentration of the heavy rare earth element decreases from the grain-boundary triple junction toward an inside of the magnetic powder grain.

2. The sintered magnet according to claim 1, wherein
a concentration gradient of the heavy rare earth element from the grain-boundary triple junction toward the inside of the magnetic powder grain is larger than the concentration gradient of the heavy rare earth element from the grain-boundary region that connects adjacent grain-boundary triple junctions toward the inside of the magnetic powder grain.

3. The sintered magnet according to claim 1, wherein
a segregation width of the heavy rare earth element from the grain-boundary triple junction toward the inside of the magnetic powder grain is larger than the segregation width of the heavy rare earth element from the grain-boundary region that connects adjacent grain-boundary triple junctions toward the inside of the magnetic powder grain.

4. The sintered magnet according to claim 1, wherein
along the grain-boundary region that connects adjacent grain-boundary triple junctions, continuity of the heavy rare earth element segregated is higher than continuity of the fluorine segregated.

5. The sintered magnet according to claim 1, wherein
the heavy rare earth element is Dy.

6. A sintered magnet configured from a magnetic powder grain having Nd₂Fe₁₄B as a main component, wherein:
fluorine, a heavy rare earth element, oxygen, and carbon are segregated in part of grain-boundary region of the sintered magnetic powder grains;
the fluorine is contained in an oxyfluoride present in the grain-boundary region; and
a crystal structure of the oxyfluoride is a cubic crystal or a tetragonal crystal.

7. A rotating electric machine using a sintered magnet configured from a magnetic powder grain having Nd₂Fe₁₄B as a main component, wherein:
in the sintered magnet, fluorine, a heavy rare earth element, oxygen, and carbon are segregated in part of grain-boundary regions of the sintered magnetic powder grains;
concentration of the carbon is higher than concentration of the fluorine at a grain-boundary triple junction of the grain-boundary region; and
concentration of the heavy rare earth element decreases from the grain-boundary triple junction toward an inside of the magnetic powder grain.

8. The rotating electric machine according to claim 7, wherein
a concentration gradient of the heavy rare earth element from the grain-boundary triple junction toward the inside of the magnetic powder grain is larger than the concentration gradient of the heavy rare earth element from the grain-boundary region that connects adjacent grain-boundary triple junctions toward the inside of the magnetic powder grain.

9. The rotating electric machine according to claim 7, wherein
a segregation width of the heavy rare earth element from the grain-boundary triple junction toward the inside of the magnetic powder grain is larger than the segregation width of the heavy rare earth element from the grain-boundary region that connects adjacent grain-boundary triple junctions toward the inside of the magnetic powder grain.

10. The rotating electric machine according to claim 7, wherein
along the grain-boundary region that connects adjacent grain-boundary triple junctions, continuity of the heavy rare earth element segregated is higher than the continuity of the fluorine segregated.
